(19) United States
(12) Patent Application Publication
(10) Pub. No.: US 2026/0104547 A1
(43) Pub. Date: Apr. 16, 2026

(54) POWER SPLITTERS

(71) Applicant: CORNING INCORPORATED, CORNING, NY (US)

(72) Inventors: John David Downie, Painted Post, NY (US); Yongmin Jung, Southampton (GB); Sijing Liang, Southampton (GB)

(21) Appl. No.: 19/357,699

(22) Filed: Oct. 14, 2025

Related U.S. Application Data
(60) Provisional application No. 63/707,869, filed on Oct. 16, 2024.

(51) Int. Cl. G02B 6/255; G02B 6/02; H04B 10/2581; H04B 10/291

(52) U.S. Cl. CPC G02B 6/2552; G02B 6/02042; G02B 6/2551; H04B 10/2581; H04B 10/2912

(57) ABSTRACT

A power splitter may include a single-core optical fiber spliced to a multicore optical fiber with a splice diameter Dₛₚ. The single-core optical fiber and the multicore optical fiber may each include: a non-tapered portion having a cladding diameter D_{S} or D_{M}, and a transition portion extending from the non-tapered portion and having a transition length L_{TS} or L_{TM}. At least one of a taper ratio R_{S} of the splice diameter Dₛₚ to the cladding diameter D_{S} of the single-core optical fiber or a taper ratio R_{M} of the splice diameter Dₛₚ to the cladding diameter D_{M} of the multicore optical fiber may be greater than or equal to 0.05 and less than or equal to 0.4. At least one of the transition length L_{TS} of the single-core optical fiber or the transition length L_{TM} of the multicore optical fiber may be greater than or equal to 2 mm.

### FIELD

This application claims the benefit of priority under 35 U.S.C. § 119 of U.S. Provisional Application Ser. No. 63/707,869 filed on Oct. 16, 2024, the content of which is relied upon and incorporated herein by reference in its entirety.

### FIELD

The present disclosure generally relates to power splitters, and, more specifically, to single-core optical fiber to multicore optical fiber power splitters utilizing a biconical splice taper and optionally, bending of the spliced fibers for efficient and uniform power distribution, and to methods of making the same.

### BACKGROUND

Multicore optical fiber technology is a promising technology for future submarine communication systems that can enable petabit-rate cable capacity by means of space division multiplexing while maintaining current cable designs. In the context of submarine optical communication, where electrical power supply to long-haul cables is constrained, power-efficient multicore optical fiber amplifiers and multicore optical fiber components, such as power splitters, are crucial for realizing functional multicore optical fiber-based optical networks. Accordingly, a need exists for efficient multicore optical fiber amplifiers and components, including power splitters.

### SUMMARY

The present disclosure includes energy-efficient power splitters for distributing optical power from a single-core optical fiber to a multicore optical fiber, thereby facilitating pump laser light distribution in amplifiers, such as multicore fiber amplifiers. The power splitters described herein offer compatibility with existing pump farming/sharing technologies, such as those utilized in submarine cable repeaters, while simplifying the construction of pump farming/sharing architectures.

In embodiments, a power splitter may include a single-core optical fiber and a multicore optical fiber. The single-core optical fiber may include a fiber axis CL_{S}; a non-tapered portion having a cladding diameter D_{S}; and a transition portion extending from the non-tapered portion from a first location to a second location, the transition portion have a transition length L_{TS} extending between the first location and the second location along the fiber axis CL_{S}. The multicore optical fiber may include a fiber axis CL_{M}; a plurality of cores; a non-tapered portion having a cladding diameter D_{M}; and a transition portion extending from the non-tapered portion from a first location to a second location, the transition portion have a transition length L_{TM} extending between the first location and the second location along the fiber axis CL_{M}. A terminal end of the single-core optical fiber may be spliced to a terminal end of the multicore optical fiber at a splice location. The terminal end of the single-core optical fiber and the terminal end of the multicore optical fiber may include a common, splice diameter Dₛₚ. At least one of a taper ratio R_{S} of the splice diameter Dₛₚ to the cladding diameter D_{S} of the non-tapered portion of the single-core optical fiber or a taper ratio R_{M} of the splice diameter Dₛₚ to the cladding diameter D_{M} of the non-tapered portion of the multicore optical fiber may be greater than or equal to 0.05 and less than or equal to 0.4. At least one of the transition length L_{TS} of the single-core optical fiber or the transition length L_{TM} of the multicore optical fiber may be greater than or equal to 2 mm. When the power splitter is in operation, the power splitter may exhibit at least one of the following: an insertion loss of the power splitter is less than or equal to 1 dB; or a power distribution variance among the plurality of cores of the multicore optical fiber is less than or equal to 10%.

In embodiments, a fiber segment may include a single-core optical fiber and a multicore optical fiber. The single-core optical fiber may include a fiber axis CL_{S}; a non-tapered portion having a cladding diameter D_{S}; and a transition portion extending from the non-tapered portion from a first location to a second location, the transition portion have a transition length L_{TS} extending between the first location and the second location along the fiber axis CL_{S}. The multicore optical fiber may include a fiber axis CL_{M}; a plurality of cores; a non-tapered portion having a cladding diameter D_{M}; and a transition portion extending from the non-tapered portion from a first location to a second location, the transition portion have a transition length L_{TM} extending between the first location and the second location along the fiber axis CL_{M}. A terminal end of the single-core optical fiber may be spliced to a terminal end of the multicore optical fiber at a splice location. The terminal end of the single-core optical fiber and the terminal end of the multicore optical fiber may include a common, splice diameter Dₛₚ. At least one of a taper ratio R_{S} of the splice diameter Dₛₚ to the cladding diameter D_{S} of the non-tapered portion of the single-core optical fiber or a taper ratio R_{M} of the splice diameter Dₛₚ to the cladding diameter D_{M} of the non-tapered portion of the multicore optical fiber may be greater than or equal to 0.05 and less than or equal to 0.4. At least one of the transition length L_{TS} of the single-core optical fiber or the transition length L_{TM} of the multicore optical fiber may be greater than or equal to 2 mm.

In embodiments, a method of manufacturing a power splitter may include providing the fiber segment described herein, coupling the single-core optical fiber of the fiber segment to a base at a first location, and coupling the multicore optical fiber to the base at a second location. In embodiments, the coupling of the single-core optical fiber to the base and the coupling of the multicore optical fiber to the base may be performed such that the power distribution variance among the plurality of cores of the multicore optical fiber is less than or equal to 10%. In embodiments, the single-core optical fiber and/or the multicore optical fiber may be bent between the first location and the second location.

In embodiments, a repeater may include a plurality of pump lasers, a coupler network configured for routing power from at least one of the plurality of pump lasers to at least one power splitter described herein, and at least one power amplifier coupled to the at least one power splitter. In embodiments, the at least one power amplifier may include a doped multicore optical fiber.

Additional features and advantages of the power splitters described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 illustrates an exemplary power splitter.

FIG. 2 schematically illustrates a side view of an exemplary power splitter.

FIG. 3 schematically illustrates a side view of an exemplary power splitter with select components removed to illustrate the splice taper of the power splitter in greater detail.

FIGS. 4A-4F schematically illustrate cross-sectional views of exemplary multicore optical fibers that may be used for the power splitters described herein.

FIGS. 5A-5C are microscopic images of various portions of a fabricated power splitter.

FIG. 6 shows measured power output from the fabricated power splitter of FIGS. 5A-5C.

FIG. 7 shows simulated power output as a function of core refractive index difference for an output multicore optical fiber having different core refractive indices.

FIGS. 8A-8F illustrates simulated effects of bending on output power distribution.

FIG. 9 plots calculated insertion loss as a function of the bending radius.

FIG. 10 schematically illustrates an exemplary platform for post processing the splice taper of the power splitters described herein.

FIG. 11 shows measured power output from the fabricated power splitter of FIGS. 5A-5C after post processing.

FIG. 12 schematically illustrates an exemplary transmission system incorporating the power splitters described herein with pump farming/sharing.

FIG. 13 schematically illustrates another exemplary transmission system incorporating the power splitters described herein with pump farming/sharing.

FIG. 14 schematically illustrates further exemplary transmission system incorporating the power splitters described herein with pump farming/sharing.

FIGS. 15A-15F shows the simulated beam propagation from the input single-core optical fiber to the output multicore optical fiber of an exemplary power splitter.

FIG. 16A plots simulated transmission loss as a function of taper ratio of exemplary power splitters.

FIG. 16B plots simulated transmission loss as a function of transition length of exemplary power splitters.

FIG. 16C plots simulated transmission loss as a function of waist length of exemplary power splitters.

FIG. 17A plots simulated transmission loss as a function of operating wavelength.

FIG. 17B plots simulated transmission loss as a function of numerical aperture of the input single-core optical fiber of exemplary power splitters.

FIG. 17C plots simulated transmission loss as a function of core pitch of the output multicore optical fiber of exemplary power splitters.

### DETAILED DESCRIPTION

Reference is now made in detail to various embodiments of the disclosure, examples of which are illustrated in the accompanying drawings. Whenever possible, the same or like reference numbers and symbols are used throughout the drawings to refer to the same or like parts. The drawings are not necessarily to scale, and one skilled in the art will recognize where the drawings have been simplified to illustrate the key aspects of the disclosure. The claims as set forth below are incorporated into and constitute part of this detailed description.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

In this specification and in the claims which follow, reference will be made to a number of terms which shall be defined to have the following meanings:

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the end-points of each of the ranges are significant both in relation to the other end-point, and independently of the other end-point.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

### Overview

Single-core to multicore optical fiber power splitters have been explored both theoretically and experimentally. However, existing power splitters face significant technical challenges, particularly in achieving low loss and/or uniform power distribution among the cores of the output multicore optical fiber. For example, existing efforts have high insertion loss (≥1 dB) and have not been able to demonstrate power variance of no greater than 10%, resulting in significant power imbalances.

Described herein are low-loss power splitters with high output power distribution uniformity. In embodiments, the power splitter described herein incorporates a biconical splice taper which enables efficient and uniform power distribution from a single-core, single-mode optical fiber to cores of a multicore optical fiber. In embodiments, the power splitter may further incorporate fiber bending to further enhance power distribution uniformity without introducing additional losses. The power splitter described herein may achieve significantly lower insertion loss (e.g., less than or equal to 0.6 dB, less than or equal to 0.3 dB, less than or equal to 0.2 dB) when compared to existing power splitters and superior power distribution uniformity (≤10% power variance among cores). The power splitter described herein may be used for pump laser power splitting/distribution in a multicore fiber amplifier. For example, the power splitter described herein may be applied to pump farming or sharing configurations in submarine repeaters, supplying pump powers to multicore fiber amplifiers, such as multicore erbium-doped fiber amplifiers (MC-EDFAs), in multicore optical fiber transmission systems.

### Power Splitter

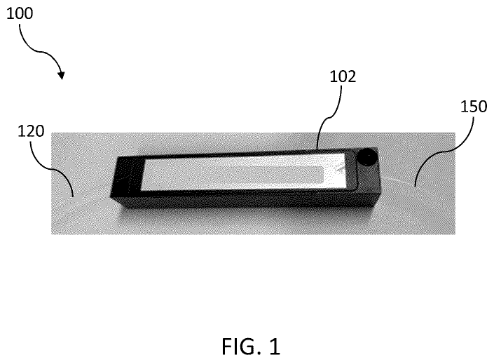

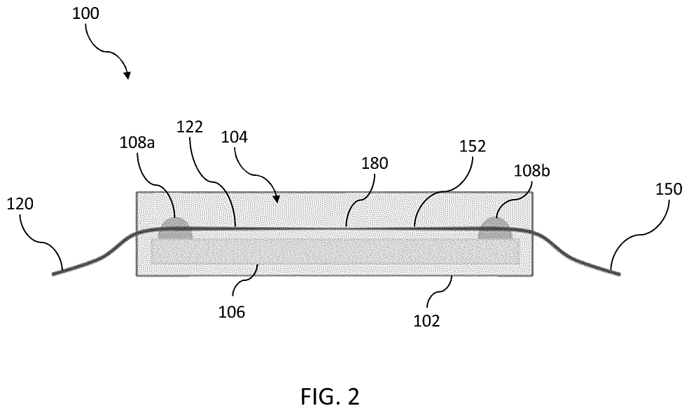

FIG. 1 illustrate an exemplary power splitter 100. FIG. 2 schematically illustrates a side view of the power splitter 100. In embodiments, the power splitter 100 may include a housing 102 defining a housing compartment 104. In FIG. 2, a portion of the housing 102 is removed from the view such that the internal structures of the power splitter 100 can be shown. In embodiments, the power splitter 100 may further include a single-core optical fiber 120 and a multicore optical fiber 150. The single-core optical fiber 120 and the multicore optical fiber 150 may be coupled to each other inside the housing compartment 104 (as will be discussed in more details below). A portion of the single-core optical fiber 120 may extend from a first end of the housing 102 outside the housing compartment 104, and a portion of the multicore optical fiber 150 may extend from a second end opposite the first end of the housing 102 outside the housing compartment 104.

Referring to FIG. 2, the power splitter 100 may further include a base 106. In embodiments, the base 106 may be secured to the housing 102 such that the base 106 and the housing 102 may not move relative to each other. In embodiments, the base 106 may be formed as an integral portion of the housing 102. The single-core optical fiber 120 may be coupled to the base 106 at a first location at the base 106 via a first coupling member 108a, and the multicore optical fiber 150 may be coupled to the base 106 at a second location at the base 106 via a second coupling member 108b. In embodiments, the first and/or second coupling members 108a, 108b may include adhesives, including but not limited to UV-curable polymers, tapes, fasteners, clamps, or any other suitable techniques or mechanisms for coupling the single-core optical fiber 120 and/or the single-core optical fiber 120 to the base 106.

The portion 122 of the single-core optical fiber 120 and the portion 152 of the multicore optical fiber 150 that are disposed between the first coupling member 108a and the second coupling member 108b may be coupled to each other and form a splice taper 180 (discussed in more detail below). The coupled portions 122, 152 and/or the splice taper 180 may be suspended in air inside the housing compartment 104 such that the coupled portions 122, 152 and/or the splice taper 180 may not contact the base 106 and/or the housing 102. Further, the single-core optical fiber 120 and/or the multicore optical fiber 150 may be secured to the base 106 via the first and second coupling members 108a, 108b such that the splice taper 180 may retain its shape and disposition inside the housing compartment 104.

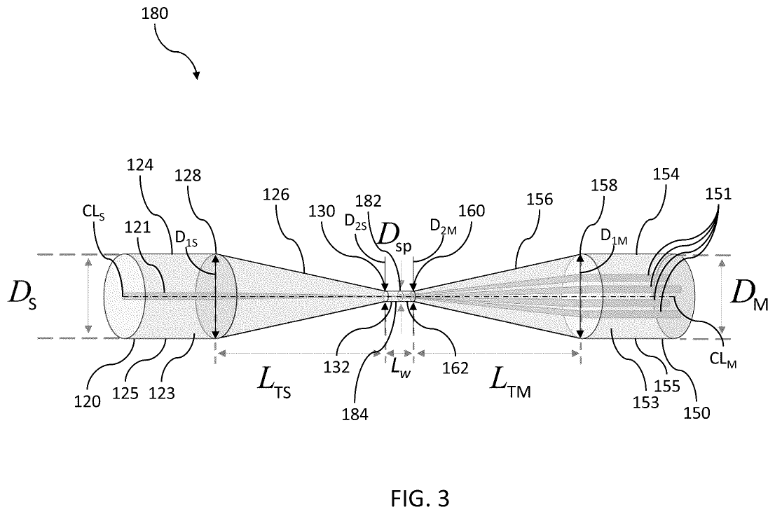

FIG. 3 is another schematic illustration of the power splitter 100 with the housing 102, the base 106, and the coupling members 108a, 108b removed to illustrate the splice taper 180 in greater detail.

### Single-Core Optical Fiber

As shown in FIG. 3, the single-core optical fiber 120 may include a glass fiber 125 having a fiber axis or centerline CL_{S} and a single core or waveguide 121 disposed in a cladding 123 along the fiber axis CL_{S}. The centerline of the core 121 may overlap and align with the fiber axis CL_{S} of the single-core optical fiber 120. In embodiments, the single-core optical fiber 120 may be a single mode optical fiber. When coupled to a pump laser, the single mode operation of the single-core optical fiber 120 may require less pump laser power as compared to multimode pumping schemes. In embodiments, the single-core optical fiber 120 may be a multimode optical fiber.

### Non-Tapered Fiber Portion

With continued reference to FIG. 3, the single-core optical fiber 120 may include a non-tapered portion 124. The cladding 123 of the single-core optical fiber 120 in the non-tapered portion 124 may have a cladding diameter D_{S}. In embodiments, the cladding diameter D_{S} of the non-tapered portion 124 of the single-core optical fiber 120, or simply referred to as the cladding diameter D_{S} of the single-core optical fiber 120, may be greater than or equal to (i.e., ≥) 60 μm and less than or equal to (i.e., ≤) 400 μm-including all sub-ranges or values therebetween. For example, in embodiments, the cladding diameter D_{S} of the single-core optical fiber 120 may be ≥60 μm and ≤400 μm, ≥60 μm and ≤350 μm, ≥60 μm and ≤300 μm, ≥60 μm and ≤250 μm, ≥60 μm and ≤200 μm, ≥60 μm and ≤150 μm, ≥60 μm and ≤100 μm, ≥100 μm and ≤400 μm, ≥100 μm and ≤350 μm, ≥100 μm and ≤300 μm, ≥100 μm and ≤250 μm, ≥100 μm and ≤200 μm, ≥100 μm and ≤150 μm, ≥150 μm and ≤400 μm, ≥150 μm and ≤350 μm, ≥150 μm and ≤300 μm, ≥150 μm and ≤250 μm, ≥150 μm and ≤200 μm, ≥200 μm and ≤400 μm, ≥200 μm and ≤350 μm, ≥200 μm and ≤300 μm, ≥200 μm and ≤250 μm, ≥250 μm and ≤400 μm, ≥250 μm and ≤350 μm, ≥250 μm and ≤300 μm, ≥300 μm and ≤400 μm, ≥300 μm and ≤350 μm, or ≥350 μm and ≤400 μm. In embodiments, the cladding diameter D_{S} of the single-core optical fiber 120 may be greater than or equal to (i.e., ≥) 60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, ≥300 μm, ≥310 μm, ≥320 μm, ≥330 μm, ≥340 μm, ≥350 μm, ≥360 μm, ≥370 μm, ≥380 μm, ≥390 μm, or greater. In embodiments, the cladding diameter D_{S} of the single-core optical fiber 120 may be less than or equal to (i.e., ≤) 400 μm, ≤390 μm, ≤380 μm, ≤370 μm, ≤360 μm, ≤350 μm, ≤340 μm, ≤330 μm, ≤320 μm, ≤310 μm, ≤300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, or less.

In embodiments, a diameter of the single core 121 may be greater than or equal to (i.e., ≥) 2 μm and less than or equal to (i.e., ≤) 30 μm-including all sub-ranges or values therebetween. For example, in embodiments, the diameter of the single core 121 may be ≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, the diameter of the single core 121 may be greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, the diameter of the single core 121 may be less than or equal to (i.e., ≤) 30 μm, ≤29 μm, ≤27 μm, ≤25 μm, ≤23 μm, ≤21 μm, ≤19 μm, ≤17 μm, ≤15 μm, ≤13 μm, ≤11 μm, ≤9 μm, ≤7 μm, ≤5 μm, ≤3 μm, or less.

In embodiments, a numerical aperture of the single core 121 may be greater than or equal to (i.e., ≥) 0.05 and less than or equal to (i.e., ≤) 0.5—including all sub-ranges or values therebetween. For example, in embodiments, the numerical aperture of the single core 121 may be ≥0.05 and ≤0.5, ≥0.05 and ≤0.45, ≥0.05 and ≤0.4, ≥0.05 and ≤0.35, ≥0.05 and ≤0.3, ≥0.05 and ≤0.25, ≥0.05 and ≤0.2, ≥0.05 and ≤0.15, ≥0.05 and ≤0.1, ≥0.1 and ≤0.5, ≥0.1 and ≤0.45, ≥0.1 and ≤0.4, ≥0.1 and ≤0.35, ≥0.1 and ≤0.3, ≥0.1 and ≤0.25, ≥0.1 and ≤0.2, ≥0.1 and ≤0.15, ≥0.15 and ≤0.5, ≥0.15 and ≤0.45, ≥0.15 and ≤0.4, ≥0.15 and ≤0.35, ≥0.15 and ≤0.3, ≥0.15 and ≤0.25, ≥0.15 and ≤0.2, ≥0.2 and ≤0.5, ≥0.2 and ≤0.45, ≥0.2 and ≤0.4, ≥0.2 and ≤0.35, ≥0.2 and ≤0.3, ≥0.2 and ≤0.25, ≥0.25 and ≤0.5, ≥0.25 and ≤0.45, ≥0.25 and ≤0.4, ≥0.25 and ≤0.35, ≥0.25 and ≤0.3, ≥0.3 and ≤0.5, ≥0.3 and ≤0.45, ≥0.3 and ≤0.4, ≥0.3 and ≤0.35, ≥0.35 and ≤0.5, ≥0.35 and ≤0.45, ≥0.35 and ≤0.4, ≥0.4 and ≤0.5, ≥0.4 and ≤0.45, ≥0.45 and ≤0.5. In embodiments, the numerical aperture of the single core 121 may be greater than or equal to (i.e., ≥) 0.05, ≥0.07, ≥0.09, ≥0.11, ≥0.13, ≥0.15, ≥0.17, ≥0.19, ≥0.21, ≥0.23, ≥0.25, ≥0.27, ≥0.29, ≥0.31, ≥0.33, ≥0.35, ≥0.37, ≥0.39, ≥0.41, ≥0.43, ≥0.45, ≥0.47, ≥0.49, or greater. In embodiments, the numerical aperture of the single core 121 may be less than or equal to (i.e., ≤) 0.5, ≤0.48, ≤0.46, ≤0.44, ≤0.42, ≤0.4, ≤0.38, ≤0.36, ≤0.34, ≤0.32, ≤0.3, ≤0.28, ≤0.26, ≤0.24, ≤0.22, ≤0.2, ≤0.18, ≤0.16, ≤0.14, ≤0.12, ≤0.1, ≤0.08, ≤0.06, or less.

The numerical aperture (NA) of an optical fiber can be measured using the method set forth in IEC-60793-1-43 (TIA SP3-2839-URV2 FOTP-177) entitled “Measurement Methods and Test Procedures—Numerical Aperture.

### Tapered Fiber Portion

The single-core optical fiber 120 may further include a tapered, transition portion 126 extending from the non-tapered portion 124 from a first location 128 to a second location 130 along the single-core optical fiber 120. In embodiments, the shape of the taper in the transition portion 126 may be linear in that the diameter of the transition portion 126 decreases linearly from the first location 128 to the second location 130. In embodiments, the shape of the taper in the transition portion 126 may be exponential in that the diameter of the transition portion 126 decreases exponentially from the first location 128 to the second location 130. Other suitable taper shape may be implemented for achieving low loss (discussed below).

A length of the transition portion 126, also referred to as the transition length L_{TS} and defined as the fiber extension between the first location 128 and the second location 130 along the fiber axis CL_{S}, may be greater than or equal to 2 mm and less than or equal to (i.e., ≤) 100 mm-including all sub-ranges or values therebetween. For example, in embodiments, the transition length L_{TS} may be ≥2 mm and ≤100 mm, ≥2 mm and ≤75 mm, ≥2 mm and ≤50 μm, ≥2 mm and ≤25 mm, ≥2 mm and ≤15 mm, ≥2 mm and ≤10 mm, ≥2 mm and ≤5 mm, ≥5 mm and ≤100 mm, ≥5 mm and ≤75 mm, ≥5 mm and ≤50 μm, ≥5 mm and ≤25 mm, ≥5 mm and ≤15 mm, ≥5 mm and ≤10 mm, ≥10 mm and ≤100 mm, ≥10 mm and ≤75 mm, ≥10 mm and ≤50 μm, ≥10 mm and ≤25 mm, ≥10 mm and ≤15 mm, ≥15 mm and ≤100 mm, ≥15 mm and ≤75 mm, ≥15 mm and ≤50 μm, ≥15 mm and ≤25 mm, ≥25 mm and ≤100 mm, ≥25 mm and ≤75 mm, ≥25 mm and ≤50 μm, ≥50 mm and ≤100 mm, ≥50 mm and ≤75 mm, or ≥75 mm and ≤100 mm. In embodiments, the transition length L_{TS} may be greater than or equal to (i.e., ≥) 2 mm, ≥5 mm, ≥10 mm, ≥15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In embodiments, the transition length L_{TS} may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, ≤15 mm, ≤10 mm, ≤5 mm, or less.

The transition portion 126 may include a first diameter D_{1S} at the first location 128. In embodiments, the first diameter D_{1S} may be the same or substantially the same as the cladding diameter D_{S} of the non-tapered portion 124 of the single-core optical fiber 120. The transition portion 126 may further include a second diameter D_{2S} at the second location 130. The second diameter D_{2S} may be less than the first diameter D_{1S}.

### End Portion

In embodiments, the single-core optical fiber 120 may further include an end portion 132 extending from the transition portion 126 to a terminal end of the single-core optical fiber 120. The terminal end of the single-core optical fiber 120 may be coupled to a terminal end of the multicore optical fiber 150 at a splice location 182 (discussed in more detail below). The terminal end of the single-core optical fiber 120 and the terminal end of the multicore optical fiber 150 may include a common, splice diameter Dₛₚ at the splice location 182.

In embodiments, a length of the end portion 132 of the single-core optical fiber 120, defined as the fiber extension between the second location 130 and the splice location 182 along the fiber axis CL_{S} of the single-core optical fiber 120, may be greater than or equal to (i.e., ≥) 0.5 mm and less than or equal to (i.e., ≤) 50 mm-including all sub-ranges or values therebetween. For example, in embodiments, the length of the end portion 132 of the single-core optical fiber 120 may be ≥0.5 mm and ≤50 mm, ≥0.5 mm and ≤25 mm, ≥0.5 mm and ≤10 mm, ≥0.5 mm and ≤5 mm, ≥0.5 mm and ≤3 mm, ≥0.5 mm and ≤1 mm, ≥1 mm and ≤50 mm, ≥1 mm and ≤25 mm, ≥1 mm and ≤10 mm, ≥1 mm and ≤5 mm, ≥1 mm and ≤3 mm, ≥3 mm and ≤50 mm, ≥3 mm and ≤25 mm, ≥3 mm and ≤10 mm, ≥3 mm and ≤5 mm, ≥5 mm and ≤50 mm, ≥5 mm and ≤25 mm, ≥5 mm and ≤10 mm, ≥10 mm and ≤50 mm, ≥10 mm and ≤25 mm, or ≥25 mm and ≤50 mm. In embodiments, the length of the end portion 132 of the single-core optical fiber 120 may be greater than or equal to (i.e., ≥) 0.5 mm, ≥1 mm, ≥1.5 mm, ≥2 mm, ≥2.5 mm, ≥3 mm, ≥3.5 mm, ≥4 mm, ≥4.5 mm, ≥5 mm, ≥6 mm, ≥7 mm, ≥8 mm, ≥9 mm, ≥10 mm, ≥15 mm, ≥20 mm, ≥25 mm, ≥30 mm, ≥35 mm, ≥40 mm, ≥45 mm, or greater. In embodiments, the length of the end portion 132 of the single-core optical fiber 120 may be less than or equal to (i.e., ≤) 50 mm, ≤45 mm, ≤40 mm, ≤35 mm, ≤30 mm, ≤25 mm, ≤20 mm, ≤15 mm, ≤10 mm, ≤9 mm, ≤8 mm, ≤7 mm, ≤6 mm, ≤5 mm, ≤4.5 mm, ≤4 mm, ≤3.5 mm, ≤3 mm, ≤2.5 mm, ≤2 mm, ≤1.5 mm, ≤1 mm, or less.

In embodiments, a ratio of the splice diameter Dₛₚ to the cladding diameter D_{S} of the non-tapered portion 124, also referred to as the taper ratio R_{S} of the single-core optical fiber 120, may be greater than or equal to (i.e., ≥) 0.05 and less than or equal to (i.e., ≤) 0.4—including all sub-ranges or values therebetween. For example, in embodiments, the taper ratio R_{S} (Dₛₚ:D_{S}) may be ≥0.05 and ≤0.4, ≥0.1 and ≤0.4, ≥0.1 and ≤0.3, ≥0.1 and ≤0.2, ≥0.2 and ≤0.4, ≥0.2 and ≤0.3, or ≥0.3 and ≤0.4. In embodiments, the taper ratio R_{S} (Dₛₚ:D_{S}) may be greater than or equal to (i.e., ≥) 0.05, ≥0.075, ≥0.1, ≥0.125, ≥0.15, ≥0.175, ≥0.2, ≥0.225, ≥0.25, ≥0.275, ≥0.3, ≥0.325, ≥0.35, ≥0.375, or greater. In embodiments, the taper ratio R_{S} (Dₛₚ:D_{S}) may be less than or equal to (i.e., ≤) 0.4, ≤0.375, ≤0.35, ≤0.325, ≤0.3, ≤0.275, ≤0.25, ≤0.225, ≤0.2, ≤0.175, ≤0.15, ≤0.125, ≤0.1, ≤0.075, or less.

### Multicore Optical Fiber

With continued reference to FIG. 3, the multicore optical fiber 150 may include a glass fiber 155 having a fiber axis or centerline CL_{M} and two or more cores or waveguides 151 disposed in a cladding 153 about the fiber axis CL_{M}. Each of the cores 151 may be a single mode core or a multi-mode core depending on the particular multicore optical fiber 150. The cores 151 may be coupled cores or uncoupled cores. In embodiments, the cladding 153 may be a solid, uniform cladding. In embodiments, the cladding 153 may not include air or hollow channels.

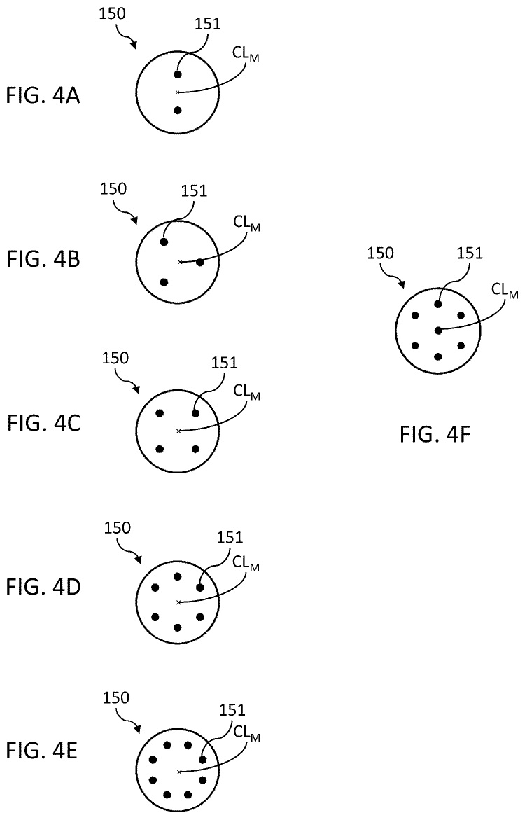

While in the exemplary embodiment shown in FIG. 3, the multicore optical fiber 150 includes four cores 151, the multicore optical fiber 150 may include less than four cores 151, more than four cores 151, or any suitable number of cores 151. In embodiments, the multicore optical fiber 150 may include two cores, three cores, four cores, five cores, six cores, seven cores, eight cores, nine cores, ten cores, or more cores. FIGS. 4A-4F schematically illustrate cross-sectional views of additional non-limiting exemplary multicore optical fibers 150. The centerline of each core 151 may be parallel to the fiber axis CL_{M} of the multicore optical fiber 150. In embodiments, the cores 151 may be arranged in an annular region about the fiber axis CL_{M}, with the centerline of each core 151 disposed at an equal radial distance from the fiber axis CL_{M}. In embodiments, the cores 151 may be equally spaced apart along the circumference of the circle on which the centerlines of the cores 151 are disposed. In embodiments, the multicore optical fiber 150 may further include a core 151 centered on or along the fiber axis CL_{M}, such as the example shown in FIG. 4F. In embodiments, no core 151 may be centered on or along the fiber axis CL_{M} of the multicore optical fiber 150, such as the example shown in FIGS. 4A-4E. Although FIGS. 4A-4F show cores 151 disposed within one annular region, in embodiments, the cores 151 may be disposed in multiple annular regions about the fiber axis CL_{M}, with the centerlines of one or more cores 151 within one annular region and the centerlines of one or more cores 151 within another annular region disposed at different radial distances from the fiber axis CL_{M}.

### Non-Tapered Fiber Portion

With further reference to FIG. 3, the multicore optical fiber 150 may include a non-tapered portion 154. The cladding 153 of the multicore optical fiber 150 in the non-tapered portion 154 may have a cladding diameter D_{M}. In embodiments, the cladding diameter D_{M} of the non-tapered portion 154 of the multicore optical fiber 150, or simply referred to as the cladding diameter D_{M} of the multicore optical fiber 150, may be greater than or equal to (i.e., ≥) 60 μm and less than or equal to (i.e., ≤) 400 μm-including all sub-ranges or values therebetween. For example, in embodiments, the cladding diameter D_{M} of the multicore optical fiber 150 may be ≥60 μm and ≤400 μm, ≥60 μm and ≤350 μm, ≥60 μm and ≤300 μm, ≥60 μm and ≤250 μm, ≥60 μm and ≤200 μm, ≥60 μm and ≤150 μm, ≥60 μm and ≤100 μm, ≥100 μm and ≤400 μm, ≥100 μm and ≤350 μm, ≥100 μm and ≤300 μm, ≥100 μm and ≤250 μm, ≥100 μm and ≤200 μm, ≥100 μm and ≤150 μm, ≥150 μm and ≤400 μm, ≥150 μm and ≤350 μm, ≥150 μm and ≤300 μm, ≥150 μm and ≤250 μm, ≥150 μm and ≤200 μm, ≥200 μm and ≤400 μm, ≥200 μm and ≤350 μm, ≥200 μm and ≤300 μm, ≥200 μm and ≤250 μm, ≥250 μm and ≤400 μm, ≥250 μm and ≤350 μm, ≥250 μm and ≤300 μm, ≥300 μm and ≤400 μm, ≥300 μm and ≤350 μm, or ≥350 μm and ≤400 μm. In embodiments, the cladding diameter D_{M} of the multicore optical fiber 150 may be greater than or equal to (i.e., ≥) 60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, ≥250 μm, ≥260 μm, ≥270 μm, ≥280 μm, ≥290 μm, ≥300 μm, ≥310 μm, ≥320 μm, ≥330 μm, ≥340 μm, ≥350 μm, ≥360 μm, ≥370 μm, ≥380 μm, ≥390 μm, or greater. In embodiments, the cladding diameter D_{M} of the multicore optical fiber 150 may be less than or equal to (i.e., ≤) 400 μm, ≤390 μm, ≤380 μm, ≤370 μm, ≤360 μm, ≤350 μm, ≤340 μm, ≤330 μm, ≤320 μm, ≤310 μm, ≤300 μm, ≤290 μm, ≤280 μm, ≤270 μm, ≤260 μm, ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, or less.

In embodiments, the cladding diameter D_{M} of the multicore optical fiber 150 may be the same as the cladding diameter D_{S} of the single-core optical fiber 120. In embodiments, a difference between the cladding diameter D_{M} of the multicore optical fiber 150 and the cladding diameter D_{S} of the single-core optical fiber 120 may be less than or equal to (i.e., ≤) 10%, ≤5%, ≤3%, ≤1%, ≤0.5%, or less, when referenced to the larger one of the cladding diameter D_{M} and the cladding diameter D_{S}.

In embodiments, a diameter of each core 151 of the multicore optical fiber 150 may be greater than or equal to (i.e., ≥) 2 μm and less than or equal to (i.e., ≤) 30 μm-including all sub-ranges or values therebetween. For example, in embodiments, the diameter of each core 151 of the multicore optical fiber 150 may be ≥2 μm and ≤30 μm, ≥2 μm and ≤25 μm, ≥2 μm and ≤20 μm, ≥2 μm and ≤15 μm, ≥2 μm and ≤10 μm, ≥2 μm and ≤5 μm, ≥5 μm and ≤30 μm, ≥5 μm and ≤25 μm, ≥5 μm and ≤20 μm, ≥5 μm and ≤15 μm, ≥5 μm and ≤10 μm, ≥10 μm and ≤30 μm, ≥10 μm and ≤25 μm, ≥10 μm and ≤20 μm, ≥10 μm and ≤15 μm, ≥15 μm and ≤30 μm, ≥15 μm and ≤25 μm, ≥15 μm and ≤20 μm, ≥20 μm and ≤30 μm, ≥20 μm and ≤25 μm, or ≥25 μm and ≤30 μm. In embodiments, the diameter of each core 151 of the multicore optical fiber 150 may be greater than or equal to (i.e., ≥) 2 μm, ≥4 μm, ≥6 μm, ≥8 μm, ≥10 μm, ≥12 μm, ≥14 μm, ≥16 μm, ≥18 μm, ≥20 μm, ≥22 μm, ≥24 μm, ≥26 μm, ≥28 μm, or greater. In embodiments, the diameter of each core 151 of the multicore optical fiber 150 may be less than or equal to (i.e., ≤) 30 μm, ≤29 μm, ≤27 μm, ≤25 μm, ≤23 μm, ≤21 μm, ≤19 μm, ≤17 μm, ≤15 μm, ≤13 μm, ≤11 μm, ≤9 μm, ≤7 μm, ≤5 μm, ≤3 μm, or less.

In embodiments, a core pitch, as defined as the distance between the centers of adjacent or nearest cores 151, may be greater than or equal to (i.e., ≥) 10 μm and less than or equal to (i.e., ≤) 60 μm-including all sub-ranges or values therebetween. In embodiments, the core pitch may be ≥10 μm and ≤60 μm, ≥10 μm and ≤50 μm, ≥10 μm and ≤40 μm, ≥10 μm and ≤30 μm, ≥10 μm and ≤20 μm, ≥20 μm and ≤60 μm, ≥20 μm and ≤50 μm, ≥20 μm and ≤40 μm, ≥20 μm and ≤30 μm, ≥30 μm and ≤60 μm, ≥30 μm and ≤50 μm, ≥30 and ≤40 μm, ≥40 μm and ≤60 μm, ≥40 μm and ≤50 μm, or ≥50 μm and ≤60 μm. In embodiments, the core pitch may be greater than or equal to (i.e., ≥) 10 μm, ≥15 μm, ≥20 μm, ≥25 μm, ≥30 μm, ≥35 μm, ≥40 μm, ≥45 μm, ≥50 μm, ≥55 μm, or greater. In embodiments, the core pitch may be less than or equal to (i.e., ≤) 60 μm, ≤55 μm, ≤50 μm, ≤45 μm, ≤40 μm, ≤35 μm, ≤30 μm, ≤25 μm, ≤20 μm, ≤15 μm, or less.

In embodiments, a numerical aperture of each core 151 may be greater than or equal to (i.e., ≥) 0.05 and less than or equal to (i.e., ≤) 0.5-including all sub-ranges or values therebetween. For example, in embodiments, the numerical aperture of each core 151 may be ≥0.05 and ≤0.5, ≥0.05 and ≤0.45, ≥0.05 and ≤0.4, ≥0.05 and ≤0.35, ≥0.05 and ≤0.3, ≥0.05 and ≤0.25, ≥0.05 and ≤0.2, ≥0.05 and ≤0.15, ≥0.05 and ≤0.1, ≥0.1 and ≤0.5, ≥0.1 and ≤0.45, ≥0.1 and ≤0.4, ≥0.1 and ≤0.35, ≥0.1 and ≤0.3, ≥0.1 and ≤0.25, ≥0.1 and ≤0.2, ≥0.1 and ≤0.15, ≥0.15 and ≤0.5, ≥0.15 and ≤0.45, ≥0.15 and ≤0.4, ≥0.15 and ≤0.35, ≥0.15 and ≤0.3, ≥0.15 and ≤0.25, ≥0.15 and ≤0.2, ≥0.2 and ≤0.5, ≥0.2 and ≤0.45, ≥0.2 and ≤0.4, ≥0.2 and ≤0.35, ≥0.2 and ≤0.3, ≥0.2 and ≤0.25, ≥0.25 and ≤0.5, ≥0.25 and ≤0.45, ≥0.25 and ≤0.4, ≥0.25 and ≤0.35, ≥0.25 and ≤0.3, ≥0.3 and ≤0.5, ≥0.3 and ≤0.45, ≥0.3 and ≤0.4, ≥0.3 and ≤0.35, ≥0.35 and ≤0.5, ≥0.35 and ≤0.45, ≥0.35 and ≤0.4, ≥0.4 and ≤0.5, ≥0.4 and ≤0.45, ≥0.45 and ≤0.5. In embodiments, the numerical aperture of each core 151 may be greater than or equal to (i.e., ≥) 0.05, ≥0.07, ≥0.09, ≥0.11, ≥0.13, ≥0.15, ≥0.17, ≥0.19, ≥0.21, ≥0.23, ≥0.25, ≥0.27, ≥0.29, ≥0.31, ≥0.33, ≥0.35, ≥0.37, ≥0.39, ≥0.41, ≥0.43, ≥0.45, ≥0.47, ≥0.49, or greater. In embodiments, the numerical aperture of each core 151 may be less than or equal to (i.e., ≤) 0.5, ≤0.48, ≤0.46, ≤0.44, ≤0.42, ≤0.4, ≤0.38, ≤0.36, ≤0.34, ≤0.32, ≤0.3, ≤0.28, ≤0.26, ≤0.24, ≤0.22, ≤0.2, ≤0.18, ≤0.16, ≤0.14, ≤0.12, ≤0.1, ≤0.08, ≤0.06, or less.

### Tapered Fiber Portion

The multicore optical fiber 150 may further include a tapered, transition portion 156 extending from the non-tapered portion 154 from a first location 158 to a second location 160 along the multicore optical fiber 150. In embodiments, the shape of the taper in the transition portion 156 may be linear in that the diameter of the transition portion 156 decreases linearly from the first location 158 to the second location 160. In embodiments, the shape of the taper in the transition portion 156 may be exponential in that the diameter of the transition portion 156 decreases exponentially from the first location 158 to the second location 160. Other suitable taper shape may be implemented for achieving low loss (discussed below).

A length of the transition portion 156, also referred to as the transition length L_{TM} and defined as the fiber extension between the first location 158 and the second location 160 along the fiber axis CL_{M}, may be greater than or equal to 2 mm and less than or equal to (i.e., ≤) 100 mm-including all sub-ranges or values therebetween. For example, in embodiments, the transition length L_{TM} may be ≥2 mm and ≤100 mm, ≥2 mm and ≤75 mm, ≥2 mm and ≤50 μm, ≥2 mm and ≤25 mm, ≥2 mm and ≤15 mm, ≥2 mm and ≤10 mm, ≥2 mm and ≤5 mm, ≥5 mm and ≤100 mm, ≥5 mm and ≤75 mm, ≥5 mm and ≤50 μm, ≥5 mm and ≤25 mm, ≥5 mm and ≤15 mm, ≥5 mm and ≤10 mm, ≥10 mm and ≤100 mm, ≥10 mm and ≤75 mm, ≥10 mm and ≤50 μm, ≥10 mm and ≤25 mm, ≥10 mm and ≤15 mm, ≥15 mm and ≤100 mm, ≥15 mm and ≤75 mm, ≥15 mm and ≤50 μm, ≥15 mm and ≤25 mm, ≥25 mm and ≤100 mm, ≥25 mm and ≤75 mm, ≥25 mm and ≤50 μm, ≥50 mm and ≤100 mm, ≥50 mm and ≤75 mm, or ≥75 mm and ≤100 mm. In embodiments, the transition length L_{TM} may be greater than or equal to (i.e., ≥) 2 mm, ≥5 mm, ≥10 mm, ≥15 mm, ≥20 mm, ≥25 mm, ≥30 mm, ≥35 mm, ≥40 mm, ≥45 mm, ≥50 mm, ≥55 mm, ≥60 mm, ≥65 mm, ≥70 mm, ≥75 mm, ≥80 mm, ≥85 mm, ≥90 mm, ≥95 mm, or greater. In embodiments, the transition length L_{TM} may be less than or equal to (i.e., ≤) 100 mm, ≤95 mm, ≤90 mm, ≤85 mm, ≤80 mm, ≤75 mm, ≤70 mm, ≤65 mm, ≤60 mm, ≤55 mm, ≤50 mm, ≤45 mm, ≤40 mm, ≤35 mm, ≤30 mm, ≤25 mm, ≤20 mm, ≤15 mm, ≤10 mm, ≤5 mm, or less.

In embodiments, the transition length L_{TM} of the transition portion 156 of the multicore optical fiber 150 may be the same as the transition length L_{TS} of the transition portion 126 of the single-core optical fiber 120. In embodiments, a difference between the transition length L_{TM} of the multicore optical fiber 150 and the transition length L_{TS} of the single-core optical fiber 120 may be less than or equal to (i.e., ≤) 10%, ≤5%, ≤3%, ≤1%, ≤0.5%, or less, when referenced to the larger one of the transition length L_{TM} and the transition length L_{TS}.

The transition portion 156 may include a first diameter D_{1M} at the first location 158. In embodiments, the first diameter D_{1M} may be the same or substantially the same as the cladding diameter D_{M} of the non-tapered portion 154 of the multicore optical fiber 150. The transition portion 156 may further include a second diameter D_{2M} at the second location 160. The second diameter D_{2M} may be less than the first diameter D_{1M}.

In embodiments, the first diameter D_{1M} of the transition portion 156 of the multicore optical fiber 150 may be the same as the first diameter D_{1S} of the transition portion 126 of the single-core optical fiber 120. In embodiments, a difference between the first diameter D_{1M} of the multicore optical fiber 150 and the first diameter D_{1S} of the single-core optical fiber 120 may be less than or equal to (i.e., ≤) 10%, ≤5%, ≤3%, ≤1%, ≤0.5%, or less, when referenced to the larger one of the first diameter D_{1M} and the first diameter D_{1S}.

In embodiments, the second diameter D_{2M} of the transition portion 156 of the multicore optical fiber 150 may be the same as the second diameter D_{2S} of the transition portion 126 of the single-core optical fiber 120. In embodiments, a difference between the second diameter D_{2M} of the multicore optical fiber 150 and the second diameter D_{2M} of the single-core optical fiber 120 may be less than or equal to (i.e., ≤) 10%, ≤5%, ≤3%, ≤1%, ≤0.5%, or less, when referenced to the larger one of the second diameter D_{2M} and the second diameter D_{2S}.

### End Portion

In embodiments, the multicore optical fiber 150 may further include an end portion 162 extending from the transition portion 156 of the multicore optical fiber 150 to a terminal end of the multicore optical fiber 150. As discussed above, the terminal end of the multicore optical fiber 150 may be coupled to the terminal end of the single-core optical fiber 120 at the splice location 182.

In embodiments, the terminal ends of the multicore optical fiber 150 and the single-core optical fiber 120 may be coupled to each other by splicing such that the fiber axis CL_{M} and the fiber axis CL_{S} are aligned. For example, the terminal ends of the multicore optical fiber 150 and the single-core optical fiber 120 may be spliced together via fusion splice using any suitable splicing equipment, such as Fujikura ARCMaster FSM-100P+ splicer.

In embodiments, a length of the end portion 162 of the multicore optical fiber 150, defined as the fiber extension between the second location 160 and the splice location 182 along the fiber axis CL_{M} of the multicore optical fiber 150, may be greater than or equal to (i.e., ≥) 0.5 mm and less than or equal to (i.e., ≤) 50 mm-including all sub-ranges or values therebetween. For example, in embodiments, the length of the end portion 162 of the multicore optical fiber 150 may be ≥0.5 mm and ≤50 mm, ≥0.5 mm and ≤25 mm, ≥0.5 mm and ≤10 mm, ≥0.5 mm and ≤5 mm, ≥0.5 mm and ≤3 mm, ≥0.5 mm and ≤1 mm, ≥1 mm and ≤50 mm, ≥1 mm and ≤25 mm, ≥1 mm and ≤10 mm, ≥1 mm and ≤5 mm, ≥1 mm and ≤3 mm, ≥3 mm and ≤50 mm, ≥3 mm and ≤25 mm, ≥3 mm and ≤10 mm, ≥3 mm and ≤5 mm, ≥5 mm and ≤50 mm, ≥5 mm and ≤25 mm, ≥5 mm and ≤10 mm, ≥10 mm and ≤50 mm, ≥10 mm and ≤25 mm, or ≥25 mm and ≤50 mm. In embodiments, the length of the end portion 162 of the multicore optical fiber 150 may be greater than or equal to (i.e., ≥) 0.5 mm, ≥1 mm, ≥1.5 mm, ≥2 mm, ≥2.5 mm, ≥3 mm, ≥3.5 mm, ≥4 mm, ≥4.5 mm, ≥5 mm, ≥6 mm, ≥7 mm, ≥8 mm, ≥9 mm, ≥10 mm, ≥15 mm, ≥20 mm, ≥25 mm, ≥30 mm, ≥35 mm, ≥40 mm, ≥45 mm, or greater. In embodiments, the length of the end portion 162 of the multicore optical fiber 150 may be less than or equal to (i.e., ≤) 50 mm, ≤45 mm, ≤40 mm, ≤35 mm, ≤30 mm, ≤25 mm, ≤20 mm, ≤15 mm, ≤10 mm, ≤9 mm, ≤8 mm, ≤7 mm, ≤6 mm, ≤5 mm, ≤4.5 mm, ≤4 mm, ≤3.5 mm, ≤3 mm, ≤2.5 mm, ≤2 mm, ≤1.5 mm, ≤1 mm, or less.

In embodiments, the length of the end portion 162 of the multicore optical fiber 150 may be the same as the length of the end portion 132 of the single-core optical fiber 120. In embodiments, a difference between the length of the end portion 162 of the multicore optical fiber 150 and the length of the end portion 132 of the single-core optical fiber 120 may be less than or equal to (i.e., ≤) 10%, ≤5%, ≤3%, ≤1%, ≤0.5%, or less, when referenced to the larger one of the length of the end portion 162 of the multicore optical fiber 150 and the length of the end portion 132 of the single-core optical fiber 120.

In embodiments, a ratio of the splice diameter Dₛₚ to the cladding diameter D_{M} of the non-tapered portion 154 of the multicore optical fiber 150, also referred to as the taper ratio R_{M} of the multicore optical fiber 150, may be greater than or equal to (i.e., ≥) 0.05 and less than or equal to (i.e., ≤) 0.4—including all sub-ranges or values therebetween. For example, in embodiments, the taper ratio R_{M} (Dₛₚ:D_{M}) may be ≥0.05 and ≤0.4, ≥0.1 and ≤0.4, ≥0.1 and ≤0.3, ≥0.1 and ≤0.2, ≥0.2 and ≤0.4, ≥0.2 and ≤0.3, or ≥0.3 and ≤0.4. In embodiments, the taper ratio R_{M} (Dₛₚ:D_{M}) may be greater than or equal to (i.e., ≥) 0.05, ≥0.075, ≥0.1, ≥0.125, ≥0.15, ≥0.175, ≥0.2, ≥0.225, ≥0.25, ≥0.275, ≥0.3, ≥0.325, ≥0.35, ≥0.375, or greater. In embodiments, the taper ratio R_{M} (Dₛₚ:D_{M}) may be less than or equal to (i.e., ≤) 0.4, ≤0.375, ≤0.35, ≤0.325, ≤0.3, ≤0.275, ≤0.25, ≤0.225, ≤0.2, ≤0.175, ≤0.15, ≤0.125, ≤0.1, ≤0.075, or less.

In embodiments, the taper ratio R_{M} (Dₛₚ:D_{M}) and the taper ratio R_{S} (Dₛₚ:D_{S}) may be the same. In embodiments, an absolute difference between the taper ratio R_{M} (Dₛₚ:D_{M}) and the taper ratio R_{S} (Dₛₚ:D_{S}) may be less than or equal to (i.e., ≤) 0.05, ≤0.04, ≤0.03, ≤0.02, ≤0.01, ≤0.008, ≤0.006, ≤0.004, ≤0.002, ≤0.001, or less.

### Taper Waist

The end portion 132 of the single-core optical fiber 120 and the end portion 162 of the multicore optical fiber 150 may collectively define a waist 184 of the splice taper 180. A waist length L_{w} of the waist 184, defined as the combined length of the end portion 132 of the single-core optical fiber 120 and the end portion 162 of the multicore optical fiber 150, may be greater than or equal to (i.e., ≥) 1 mm and less than or equal to (i.e., ≤) 100 mm-including all sub-ranges or values therebetween. For example, in embodiments, the waist length L_{w} may be ≥1 mm and ≤100 mm, ≥1 mm and ≤50 mm, ≥1 mm and ≤25 mm, ≥1 mm and ≤10 mm, ≥1 mm and ≤5 mm, ≥1 mm and ≤3 mm, ≥3 mm and ≤100 mm, ≥3 mm and ≤50 mm, ≥3 mm and ≤25 mm, ≥3 mm and ≤10 mm, ≥3 mm and ≤5 mm, ≥5 mm and ≤100 mm, ≥5 mm and ≤50 mm, ≥5 mm and ≤25 mm, ≥5 mm and ≤10 mm, ≥10 mm and ≤100 mm, ≥10 mm and ≤50 mm, ≥10 mm and ≤25 mm, ≥25 mm and ≤100 mm, ≥25 mm and ≤50 mm, or ≥50 mm and ≤100 mm. In embodiments, the waist length L_{w} may be greater than or equal to (i.e., ≥) 1 mm, ≥3 mm, ≥5 mm, ≥7 mm, ≥9 mm, ≥10 mm, ≥20 mm, ≥30 mm, ≥40 mm, ≥50 mm, ≥60 mm, ≥70 mm, ≥80 mm, ≥90 mm, or greater. In embodiments, the waist length L_{w} may be less than or equal to (i.e., ≤) 100 mm, ≤90 mm, ≤80 mm, ≤70 mm, ≤60 mm, ≤50 mm, ≤40 mm, ≤30 mm, ≤20 mm, ≤10 mm, ≤9 mm, ≤8 mm, ≤7 mm, ≤6 mm, ≤5 mm, ≤4 mm, ≤3 mm, ≤2 mm, or less.

In embodiments, a diameter of the waist 184 may be consistent along the entire length L_{w} of the waist 184. In embodiments, the variation of the diameter of the waist 184, as referenced to the splice diameter Dₛₚ, may be less than or equal to (i.e., ≤)±3 μm, ≤±1 μm, ≤±0.5 μm, ≤±0.3 μm, ≤±0.1 μm, ≤±0.05 μm, or less.

### Smooth Transitions

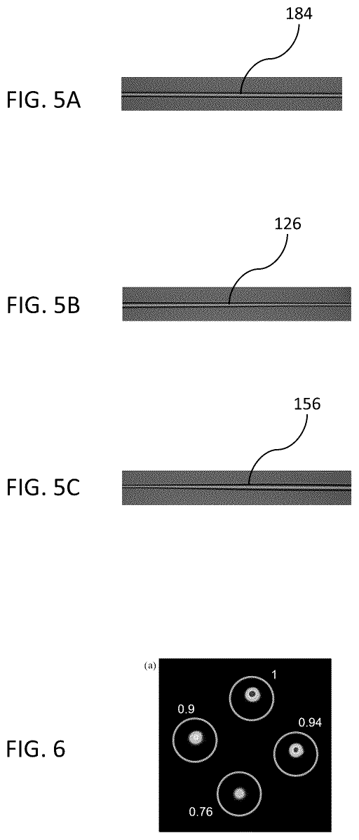

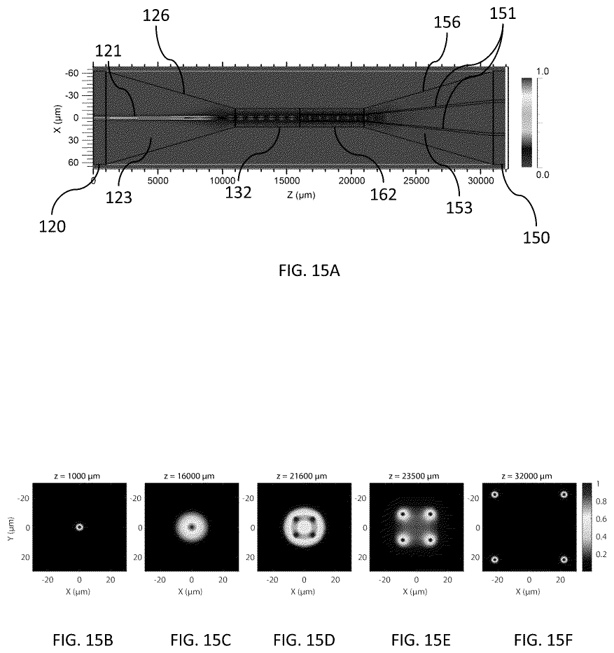

While in the schematics of the present disclosure, e.g., FIG. 3 and FIG. 15A discussed below, the transitions from the non-tapered portions 124, 154 to the respective transition portions 126, 156 and the transitions from the transition portions 126, 156 to the respective end portions 132, 162 are shown as sharp transitions for purposes of illustration, it should be noted that the profile of the splice taper 180 are created in a manner such that the transitions are smooth, such as shown in FIG. 2 and FIG. 5, for limiting transmission loss. For example, after the single-core optical fiber 120 and the multicore optical fiber 150 are spliced together, the coupled/spliced fibers 120, 150 may be heated and stretched so as to form the taper profile of the splice taper 180 by, e.g., using a splicing equipment in embodiments. The heating and/or stretching may be controlled such that the desired length of each of the end portions 132, 162 or the desired length of the waist 184, the desired length of each of the transition portions 126, 156, and the desired taper ratios R_{S}, R_{M} may be obtained, and the transitions from the end portions 132, 152 to the respective adjacent transition portions 126, 156 and the transitions from the transition portions 126, 156 to the respective adjacent non-tapered portions 124, 154 may be smooth.

It should be noted that although the transitions are smooth, the various portions may still be ascertained by examining the diameter profile of any splice taper 180 along the fiber axes CL_{S}, CL_{M}. For example, the smallest diameter Dₘᵢₙ along the diameter profile of the splice taper 180, which corresponds to the splice diameter Dₛₚ, may be found along the length of the splice taper 180 using any known techniques for measuring fiber diameters, including but not limited to microscopic imaging. Alternatively, the splice location 182 can be first detected using known techniques and/or tools, then the splice diameter Dₛₚ at the splice location 182 can be measured. The cladding diameters D_{S}, D_{M} can also be determined along the respective non-tapered portions 124, 154 of the single-core optical fiber 120 and multicore optical fiber 150 using any known techniques for measuring fiber diameters, including but not limited to microscopic imaging. Then, starting from the splice location 182 or a location having the smallest diameter Dₘᵢₙ, the second location 130 along the fiber axis CL_{S} of the single-core optical fiber 120 can be defined as the location at which the diameter of the single-core optical fiber 120 becomes or increases to 1.05×Dₛₚ or 1.05 Dₘᵢₙ; starting from the splice location 182 or the location having the smallest diameter Dₘᵢₙ, the second location 160 along the fiber axis CL_{M} of the multicore optical fiber 150 can be defined as the location at which the diameter of the multicore optical fiber 150 becomes or increases to 1.05×Dₛₚ or 1.05 Dₘᵢₙ. Further, starting from the splice location 182 or the location having the smallest diameter Dₘᵢₙ or the second location 130, the first location 128 along the fiber axis CL_{S} of the single-core optical fiber 120 can be defined as the location at which the diameter of the single-core optical fiber 120 becomes or increases to 0.98×D_{S}; starting from the splice location 182 or the location having the smallest diameter Dₘᵢₙ or the second location 160, the first location 158 along the fiber axis CL_{M} of the multicore optical fiber 150 can be defined as the location at which the diameter of the multicore optical fiber 150 becomes or increases to 0.98×D_{M}. Once the first and second locations 128, 158, 130, 160 are determined, the lengths of the transition portions 126, 156 and the waist 184 or combined end portions 132, 162 can then be determined accordingly. The taper ratios R_{S}, R_{M} can also be determined based on the measured splice diameter Dₛₚ or the measured smallest diameter Dₘᵢₙ and cladding diameters D_{S}, D_{M}.

### Adiabatic Taper

In addition to the smooth transitions between adjacent portions, the splice taper 180 may also be configured with appropriate taper ratios R_{S}, R_{M} so that the overall taper profile may be smooth to achieve an adiabatic taper for low loss. Typically, it may be desired to have larger taper ratios so as to achieve a smooth adiabatic taper for low loss. However, the inventors have discovered that relatively small taper ratios R_{S}, R_{M}, e.g., from 0.05 to 0.4, of the power splitter 100 described herein achieve surprisingly low insertion. Without intending to be bound by theory, the relatively small taper ratios R_{S}, R_{M} of the power splitter 100 described herein, when combined with relatively large transition lengths L_{TS}, L_{TM} described herein, may nonetheless achieve an adiabatic taper, which may in turn facilitate obtaining low insertion loss of the power splitter 100 described herein. As discussed above, the shape of the taper may be linear (with linearly decreasing cladding diameter), exponential (with exponentially decreasing cladding diameter), or other suitable shape for achieving an adiabatic taper.

### Symmetrical Tapering

In addition to being smooth or adiabatic, the splice taper 180 may also be created such that the taper profile of the splice taper 180 may be symmetrical about the splice location 182 to further limit insertion loss of the power splitter 100. For example, in embodiments, the cladding diameter D_{S} and the cladding diameter D_{M} may be the same. In embodiments, the length of the end portion 132 of the single-core optical fiber 120 and the length of the end portion 162 of the multicore optical fiber 150 may be the same. In embodiments, the transition length L_{TS} of the single-core optical fiber 120 and the transition length L_{TM} of the multicore optical fiber 150 may be the same. In embodiments, the taper ratio R_{S} (Dₛₚ:D_{S}) of the single-core optical fiber 120 and the taper ratio R_{M} (Dₛₚ:D_{M}) of the multicore optical fiber 150 may be the same. Accordingly, the taper profile of the splice taper 180 may be symmetrical about the splice location 182 in embodiments. The splice location 182 may be the midpoint of the waist 184 of the splice taper 180 in embodiments.

### Low Insertion Loss

The smooth adiabatic profile of the splice taper 180 (e.g., the taper ratios R_{S} (Dₛₚ:D_{S}) and R_{M} (Dₛₚ:D_{M}), the lengths of the transition portions 126, 156, etc.), and/or the symmetrical tapering of the single-core optical fiber 120 and the multicore optical fiber 150 about the splice location 182, may allow the power splitter 100 described herein to achieve much lower insertion loss compared to existing power splitters. The insertion loss, expressed in decibels, is defined as follows:

$$Insertion Loss ( dB ) = - 10 \times {log}_{10} \frac{{P}_{output}}{{P}_{input}}$$

where Pₒᵤₜₚᵤₜ is the combined output power from all cores 151 of the multicore optical fiber 150, and Pᵢₙₚᵤₜ is the power input into the single-core optical fiber 120. In embodiments, the insertion loss of the power splitter 100 described herein is less than or equal to (i.e., ≤) 1 dB, ≤0.8 dB, ≤0.6 dB, ≤0.5 dB, ≤0.4 dB, ≤0.3 dB, ≤0.2 dB, ≤0.1 dB, ≤0.08 dB, ≤0.06 dB, ≤0.04 dB, ≤0.03 dB, or less. Additionally, the low loss of the power splitter 100 may be achieved over a broad wavelength range. For example, the low loss of the power splitter 100 may be achieved for wavelengths greater than or equal to (i.e., ≥) 400 nm and less than or equal to (i.e., ≤) 2000 nm-including all sub-ranges or values therebetween.

### Uniform Power Distribution

The smooth adiabatic profile of the splice taper 180 and/or the symmetrical tapering of the single-core optical fiber 120 and the multicore optical fiber 150 about the splice location 182 may further allow the power splitter 100 to achieve low power distribution variance among the cores 151 of the multicore optical fiber 150. The power distribution variance among the cores 151 of the multicore optical fiber 150 is defined as follows:

$$Power Distribution Variance ( \% ) = \frac{Max ( power values of all cores ) - Min ( power values of all cores )}{Max ( power values of all cores )}$$

In embodiments, the power distribution variance among the cores 151 of the multicore optical fiber 150 of the power splitter 100 described herein may be less than or equal to (i.e., ≤) 10%, ≤9%, ≤8%, ≤7%, ≤6%, ≤5%, ≤4%, ≤3%, ≤2%, ≤1%, or less.

### Post-Processing of Fiber Taper

### Effects of Core Variations on Power Distribution

While the splice taper 180 described above may facilitate efficient and uniform power distribution from the single-core optical fiber 120 to the multicore optical fiber 150, in some instances, the power distribution among the cores 151 of the multicore optical fiber 150 may nonetheless vary due to other factors.

FIGS. 5A-5C are microscopic images of the various portions of a power splitter fabricated using a Fujikura ARCMaster FSM-100P+ splicer in accordance with the embodiments described herein. The fabrication of the power splitter involves a two-step process: 1. Splicing an input, single-core optical fiber to an output, multicore (four-core) optical fiber; 2. Tapering the spliced fibers. The taper program of the splicer was set up to demonstrate a taper ratio of 0.2 and a transition length of 8 mm for both the single-core optical fiber and the multicore optical fiber, and a waist length of 2 mm (18 mm of the total taper length). According to the simulation, such taper design yields a loss of 0.2 dB at 1 μm, with equal power distribution into the four cores of the multicore optical fiber 150. FIG. 5A shows the waist of the splice taper of the fabricated power splitter, FIG. 5B shows the transition portion of the single-core optical fiber of the fabricated power splitter, and FIG. 5C shows the transition portion of the multicore optical fiber of the fabricated power splitter. As shown in the images of FIGS. 5A-5C, the splice taper is a smooth adiabatic taper with accurate taper ratios R_{M}, R_{S} and transition portion lengths.

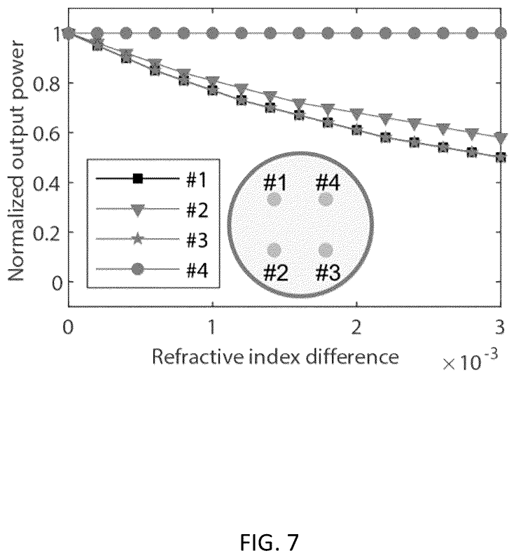

The fabricated power splitter was tested with a broadband 1-μm amplified spontaneous emission (ASE) source. The measured insertion loss was 0.6 dB. The output of the fabricated power splitter was also characterized by a CCD camera to measure the power distribution uniformity among the cores of the multicore optical fiber. Details of the output power measuring method is described in Zhang, Ziyang, et al. “Fiber-based three-dimensional multi-mode interference device as efficient power divider and vector curvature sensor.” Journal of Optics 20.3 (2018): 035701, the content of which is incorporated herein by reference. As shown in FIG. 6, the measured power output is not uniform among the cores, and the power difference between the core having the maximum power and the core having the minimum power was about 25%.

Without intending to be bound by theory, the inventors believe that deviation of the measured insertion loss and/or the power distribution from the simulation results may be attributed at least in part to practical challenges associated with, e.g., the manufacturing of the multicore optical fibers, where the cores may exhibit a variation in core diameter, core refractive index, core numerical aperture (NA), etc.

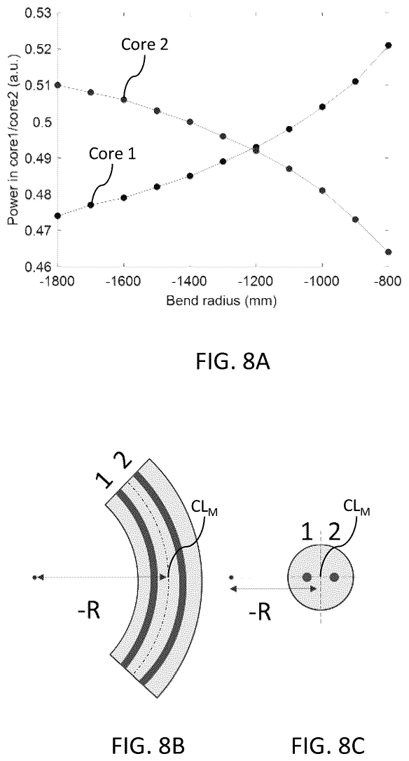

For example, simulations have revealed that even a small difference in the core refractive index (e.g., on the order of 10-3) among the cores of the multicore optical fiber can significantly impact power distribution from the single-core optical fiber to the multicore optical fiber, such as shown in FIG. 7, which is a simulated plot of the normalized output power for each core in a four-core multicore optical fiber as a function of the core refractive index difference. For the simulation of FIG. 7, it is assumed that core #4 has a slightly higher refractive index than the other three cores which have the same core numerical aperture (NA=0.21). Employing the following parameters: R_{S}=R_{M}=0.2, L_{w}=2 mm, L_{TS}=L_{TM}=8 mm, λ=1 μm, multicore optical fiber core diameter=3.3 μm, calculations consistently reveal that core #4 (with the highest core refractive index) has the maximum output power. The power difference between the core exhibiting maximum output power and the core exhibiting minimum output power increases proportionally with the core refractive index difference.

Post Processing with Controlled Bending

To address the power imbalance associated with challenges such as variations in core refractive indices, numerical apertures, diameters, etc., the inventors have discovered that post processing of the fiber taper may be performed to manipulate the output power distribution, thereby improving the uniformity of power distribution among the cores. Specifically, after the fibers have been spliced and the taper formed, controlled fiber bending may be applied to the splice taper, leading to improved power imbalance and enhancing the power splitter's practical realization.

Without intending to be bound by theory, the inventors have recognized that power coupling between cores may take place in the transition portion of the multicore optical fiber where the core pitch is reduced, light confinement in core may be weakened, and supermodes may be excited. By applying controlled bending, the supermode transition in the transition portion of the multicore optical fiber may be impacted, thereby allowing manipulation of the power distribution among the cores of the multicore optical fiber.

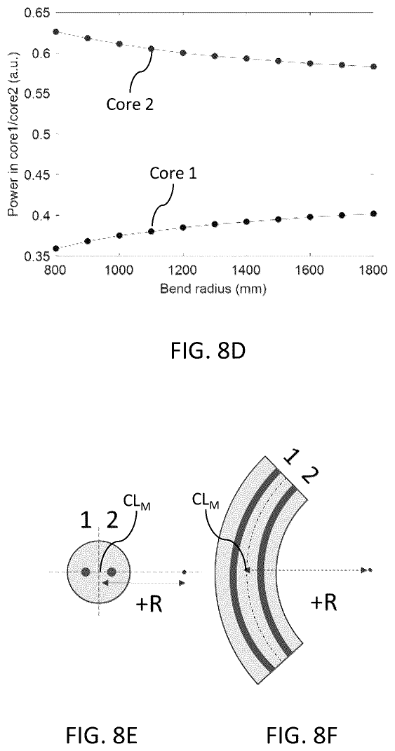

The direction and/or strength/magnitude of bending applied may be adjusted to achieve power distribution uniformity. As a non-limiting example, FIGS. 8A-8F illustrates the simulated effects of bending on output power distribution of a power splitter employing a single-core optical fiber as the input fiber and a two-core multicore optical fiber as the output fiber. Specifically, FIG. 8A plots the output power in core 1 and core 2 of the multicore optical fiber as a function of the bending radius, and FIGS. 8B and 8C are diagrams schematically illustrating the corresponding bending direction and bending radius associated with FIG. 8A; FIG. 8D plots the output power in core 1 and core 2 as a function of the bending radius, and FIGS. 8E and 8F are corresponding diagrams schematically illustrating the corresponding bending direction and bending radius associated with FIG. 8D. The following parameters are employed for the simulation at 2=1550 nm: the core diameters of the single-core optical fiber and the multicore optical fiber are set to be 9 μm (NA=0.12); core pitch of the two-core multicore optical fiber is 50 μm; it is assumed that core 2 has a greater refractive index than core 1, leading to the power distribution imbalance.

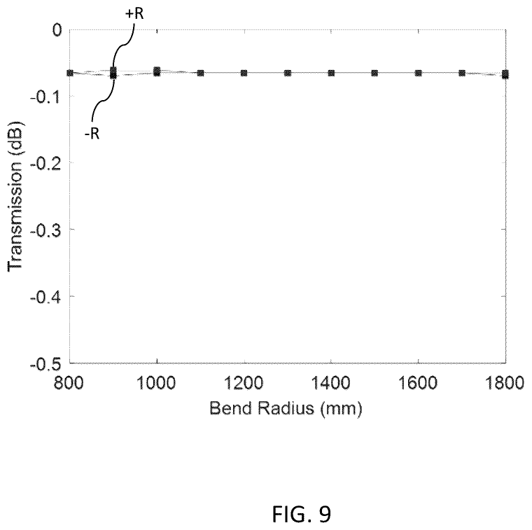

As shown, by adjusting the direction and strength/magnitude (e.g., bending radius), induced bending may improve power distribution uniformity. For example, as shown in FIGS. 8A-8C, when the fiber is bent towards core 1 having the lower refractive index with a bending radius of about −1200 mm, the output powers in core 1 and core 2 become equal, while the loss of the power splitter remains low. As shown in FIG. 9, which plots the calculated insertion loss as a function of the bending radius, the total transmitted power remains substantially constant within a wide range of bending radius for both bend conditions shown in FIGS. 8A-F.

### Setup for Post Processing

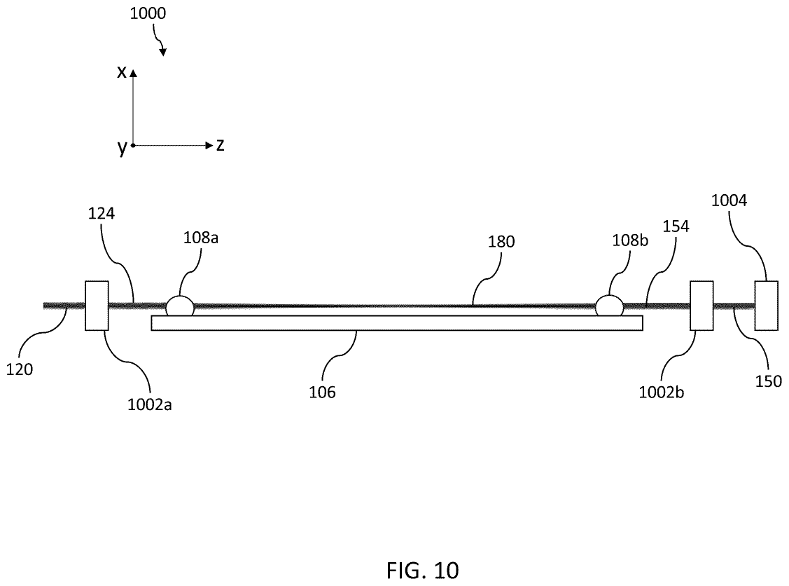

FIG. 10 schematically illustrates a non-limiting, exemplary platform 1000 for post processing the splice taper 180 to introduce bending to further improve power distribution uniformity. The platform 1000 may include a first stage 1002a and a second stage 1002b. The first stage 1002a may be configured to hold the single-core optical fiber 120 at a suitable location along the non-tapered portion 124 of the single-core optical fiber 120. The second stage 1002b may be configured to hold the multicore optical fiber 150 at a suitable location along the non-tapered portion 154 of the multicore optical fiber 150. The x, y, and z axes of the Cartesian coordinate system is shown in FIG. 10 for purpose of illustration. In the setup as shown in FIG. 10, the portion of the splice taper 180 between the first stage 1002a and the second stage 1002b may be generally aligned along the Z direction while being held by the first stage 1002a and the second stage 1002b before any bending may be applied.

In embodiments, at least one of the first stage 1002a and/or the second stage 1002b may be configured to bend the splice taper 180 in the X-Z plane, Y-Z plane, or a combination thereof to apply controlled bending to the splice taper 180. In embodiments, at least one of the first stage 1002a and/or the second stage 1002b may be further configured to rotate the splice taper 180 about the fiber axis CL_{S} and/or the fiber axis CL_{M}, which are aligned after the fibers 120, 150 are spliced together and tapered. In embodiments, rotation of the splice taper 180 may be performed in combination with bending of the splice taper 180 to facilitate adjusting the bending directions and/or bending radii for individual cores 151 within the multicore optical fiber 150. Using the bending shown in FIGS. 8B, 8C, 8E, and 8F as an example, to change from the applied bending (−R) shown in FIGS. 8B and 8C to the applied bending (+R) shown in FIGS. 8E and 8F, the first stage 1002a and/the second stage 1002b may change the bending direction of the splice taper 180 in the opposite direction to achieve the opposition bending radii (from −R to +R) in some embodiments. In embodiments, the first stage 1002a and/or the second stage 1002b may maintain the same bending (e.g., −R) of the splice taper 180 about the fiber axis CL_{M} and but rotate the splice taper 180 about the fiber axis CL_{M} by 180 degrees to achieve effectively the same absolute values of the bending radii for core 1 and core 2, respectively, as shown in FIGS. 8E and 8F. Although 180 degrees of rotation is applied in the example for illustration purposes, any degrees of rotation may be applied to achieve desired amount of bending for individual cores 151 within the multicore optical fiber 150 to improve power distribution uniformity. Further, rotation of the splice taper 180 may be applied prior to, after, or simultaneously with bending of the splice taper 180. In embodiments, the rotation may be applied such that the splice taper 180 may not be twisted about the fiber axes CL_{S}, CL_{M}. In embodiments, the rotation may be applied such that the splice taper 180 may also be twisted about the fiber axis CL_{S} and/or fiber axis CL_{M} for modifying the output power for individual cores.

As controlled bending and/or rotation may be applied, the power distribution among the cores 151 of the multicore optical fiber 150 may be monitored using a power monitor 1004, such as a CCD camera, coupled to the output end of the multicore optical fiber 150. The monitor 1004 may be configured to measure the powers among the cores in real time such that the direction and strength/magnitude of the bending, as well as rotation, may be adjusted until the desired power distribution uniformity is achieved. Then the splice taper 180 may be secured to the base 106 by the first and second coupling members 108a, 108b such that the induced bending and/or rotation is maintained for the portion of the splice taper 180 between the first and second coupling members 108a, 108b. The base 106 and the splice taper 180 coupled thereto may then be packaged into the housing 102 (not shown in FIG. 10) of the power splitter 100. In embodiments, the first and/or second coupling members 108a, 108b may include a curable polymeric adhesive. The curable polymeric adhesive may be applied without curing thereby allowing adjustments to the bending and/or rotation applied. Once the desired power distribution uniformity is achieved, the adhesive may be cured, e.g., by UV light, while the splice taper 180 is being held in place by the first stage 1002a and second stage 1002b. The cured adhesive retains the applied bending and/or rotation for achieving the uniform power distribution. The splice taper 180 may then be removed from the first stage 1002a and the second stage 1002b after the adhesive is cured.

In embodiments, the absolute value of the resultant bending radius of the portion of the splice taper 180 between the first and second coupling members 108a, 108b may be greater than or equal to (i.e., ≥) 10 mm, ≥100 mm, ≥300 mm, ≥500 mm, ≥600 mm, ≥700 mm, ≥800 mm, ≥900 mm, ≥1000 mm, ≥1100 mm, ≥1200 mm, ≥1300 mm, ≥1400 mm, ≥1500 mm, ≥1600 mm, ≥1700 mm, ≥1800 mm, ≥1900 mm, ≥2000 mm, or up to infinity (i.e., no bending).

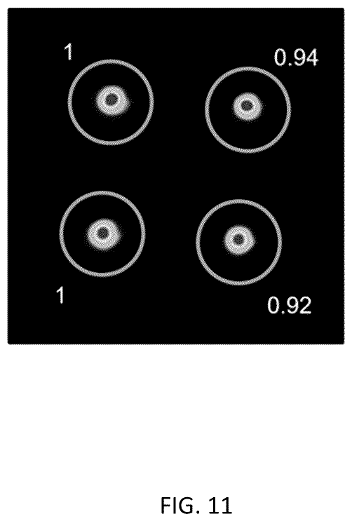

FIG. 11 shows the power distribution of the same splice taper discussed above with reference to FIGS. 5A-5C and 6, after applying controlled bending and/or rotation and securing and packaging the splice taper to the base/housing of the power splitter. As shown in FIG. 11, the power difference between the core having the maximum power and the core having the minimum power was about 8%—a significant reduction from the 25% power distribution variance shown in FIG. 6 when no bending was applied. Further, negligible impact on the performance of the power splitter was observed after applying controlled bending and packaging. The insertion loss after applying controlled bending and packaging was 0.6 dB with the loss increment being less than 0.2 dB, and the power distribution remained stable. Accordingly, by applying controlled bending to the splice taper, the power distribution uniformity may be improved without significantly increasing loss.

It should be noted that although post processing, e.g., controlled bending, after the single—core optical fiber and the multicore optical fiber are spliced and tapered, may facilitate achieving uniform power distribution, such post processing may not be required, such as in the case where the cores of the output multicore optical fiber may be sufficiently uniform, yielding sufficient level of power distribution uniformity without further induced bending.

### Advantages

Using the power splitter described herein, many benefits and advantages can be achieved. For example, the power splitter described herein exhibits remarkably high efficiency, such as low insertion loss of 0.2 dB in theory and low insertion loss of 0.3 dB in experimental demonstration in some embodiments. The high efficiency of the power splitter described herein contributes significantly to developing energy-efficient multicore optical fiber amplifiers and constructing sustainable submarine optical networks. Additionally, with optional post processing, e.g., controlled bending, practical technical challenges associated with fiber fabrication can be addressed, and more uniform power distribution may be achieved (e.g., ≤10% power variance among cores) even when variations in cores of the output multicore optical fiber may not be avoided. Controlled bending post splicing and tapering can thus provide additional flexibility for improving power distribution uniformity. Moreover, with an all-fiber construction, i.e., using only input single-core optical fiber and output multicore optical fiber via a simple two-step process (splicing and tapering) and optional post-process (e.g., controlled bending), the power splitter described herein allows for cost-efficient manufacturing.

Furthermore, the power splitter described herein may be constructed with diverse types of input single-core optical fibers and/or output multicore optical fibers, thereby avoiding the need to modify the splice taper design individually for different input and/or output optical fibers. Additionally, by employing the splice taper design, the power splitter described herein may provide more flexibility in the choice of input single-core optical fiber as it is not required for the mode field diameters between the single-core optical fiber and the multicore optical fiber to match each other. In addition to the wide applicability to various input and/or output fibers, the power splitter described herein further allow for low-loss operation across a very broad wavelength range (e.g., 400 nm to 2000 nm).

### Application in Transmission Systems

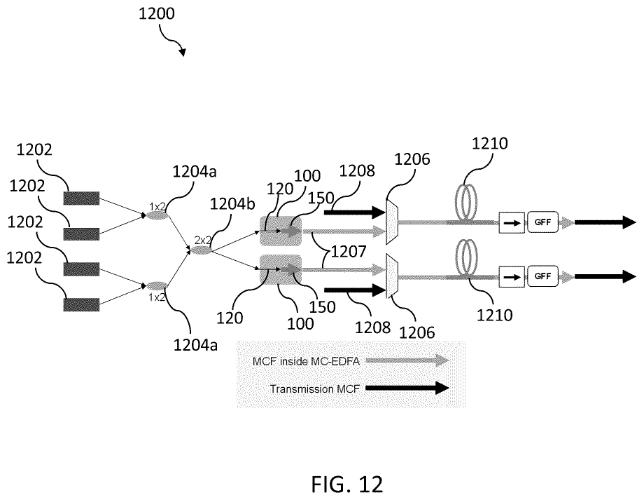

The power splitter described herein may be used for optical fiber transmission systems where multicore fiber amplifiers may be employed for simultaneous amplification of multiple cores, such as in submarine cable repeaters. FIG. 12 schematically illustrates an exemplary system 1200, such as a repeater, using multicore fiber amplifiers, such as multicore erbium-doped fiber amplifiers (MC-EDFAs), and the power splitter described herein with pump farming (pump sharing).

The system 1200 may include two or more pump lasers 1202. The pump lasers 1202 may be coupled to one or more the power splitters 100 described herein, more specifically, coupled to the input single-core optical fibers 120 of the power splitters 100, via one or more power couplers 1204. The coupling between each pump laser 1202 and a power coupler 1204 may be achieved by splicing the output end of the pump laser 1202 and the input end of the power coupler 1204. The coupling between each power splitter 100 and a power coupler 1204 may be achieved by splicing the input end of the single-core optical fiber 120 of the power splitter 100 and the output end of the power coupler 1204.

Each of the power splitter 100 may be coupled to a wavelength division multiplexer (WDM) 1206. The coupling between the power splitter 100 and the WDM 1206 may be achieved by splicing the output end of the multicore optical fiber 150 of the power splitter 100 and the input end of a multicore optical fiber 1207 of the WDM 1206. The WDM 1206 may be configured for combing the power output from the multicore optical fiber 150 of the power splitter 100 and the signal to be amplified, which may be carried over a transmission multicore optical fiber 1208 and subsequently amplified by a doped multicore optical fiber 1210, such as an erbium-doped multicore optical fiber, of a multicore fiber amplifier. In embodiments, the multicore optical fiber 150 of the power splitter 100 may include the same number of cores as the doped multicore optical fiber 1210, the transmission multicore optical fiber 1208, and/or the input multicore optical fiber 1207 of the WDM 1206.

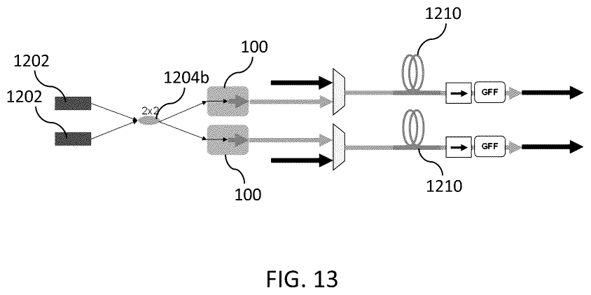

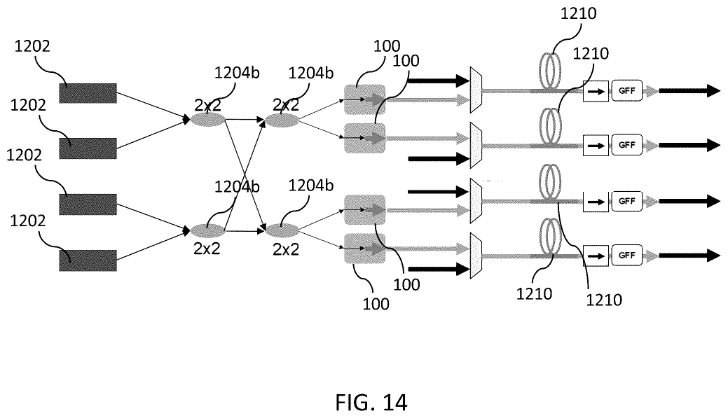

While FIG. 12 illustrates four pump lasers 1202 configured for pumping two doped multicore optical fibers 1210 that share the four pump lasers 1202, any suitable number of pump lasers 1202 may be shared by any suitable number of doped multicore optical fibers 1210 using the power splitters 100 described herein and appropriate coupling configuration between the pump lasers 1202 and the power splitters 100. For example, in the example shown in FIG. 12 where four pump lasers 1202 are configured for pumping two doped multicore optical fibers 1210 via two power splitters 100, each pair of pump lasers 1202 may be coupled to a 1×2 power coupler 1204a, which may then be further coupled to a 2×2 power coupler 1204b for coupling to the power splitters 100. As another example shown in FIG. 13 where two pump lasers 1202 are configured for pumping two doped multicore optical fibers 1210 via two power splitters 100, the single pair of pump lasers 1202 may be coupled to each of the two power splitters 100 via a 2×2 power coupler 1204b. As a further example shown in FIG. 14 where four pump lasers 1202 are configured for pumping four doped multicore optical fibers 1210 via four power splitters 100, each pair of pump lasers 1202 may be coupled to a 2×2 power coupler 1204b, which may then be further coupled to two 2×2 power couplers 1204b each of which may be coupled to two of the four power splitters 100. The examples shown in FIGS. 12 and 14 are non-limiting and for illustrative purposes only. Any other suitable configuration for coupling the pump lasers 1202 to the power splitters 100 and further to the doped multicore optical fibers 1210 may be utilized as would be appreciated by one skilled in the art.

The power splitters described herein allow for simultaneous amplification of multiple cores utilizing multicore fiber amplifiers. By utilizing the power splitters described herein, the coupler network architectures (or configuration of the power couplers) for coupling the shared pump lasers to the power splitter(s) are simpler than those that would be required for the same number of pump lasers pumping individual single-core optical fibers (e.g., 8 individual single-core optical fibers or 16 individual single-core optical fibers) instead of pumping multicore optical fibers (e.g., 2 four-core multicore optical fibers or 4 four-core multicore optical fibers). Additionally, by splitting the power from one pump laser into multiple cores, the power splitter described herein allow power from one pump laser to be shared by multiple cores, allowing for a more cost-efficient and more energy-efficient design to be implemented.

### EXAMPLES

The embodiments described herein will be further clarified by the following additional examples.

### Beam Propagation Simulation

FIG. 15A shows the simulation of light propagation from the input single-core single mode optical fiber 120 to the output four-core multicore optical fiber 150 of an exemplary power splitter 100 according to embodiments described herein. The intensity profile is taken at the centerlines of the single-core optical fiber 120 and the multicore optical fiber 150 (y=0 location in FIG. 15A) along the fiber axes CL_{S}, CL_{M} (z direction in FIG. 15A). The simulation is based on the beam propagation method as described in R. Scarmozzino, A. Gopinath, R. Pregla and S. Helfert, “Numerical techniques for modeling guided-wave photonic devices,” in IEEE Journal of Selected Topics in Quantum Electronics, vol. 6, no. 1, pp. 150-162, January-February 2000, doi: 10.1109/2944.826883, the content of which is incorporated herein by reference in its entirety. FIGS. 15B-15F further show the calculated transverse field profiles at different fiber locations. As the cladding diameter of the single-core optical fiber 120 gradually decreases in the transition portion 126, light starts to leak into the cladding 123 of the single-core optical fiber 120, and the propagation mode changes from the core mode (FIG. 15B) to cladding mode (FIG. 15C). In the waist or the spliced end portions 132, 162, the effects of the core 121 of the single-core optical fiber 120 and the cores 151 of the multicore optical fiber 150 on beam propagation are negligible, the propagation mode in the end portion 132 of the single-core optical fiber 120 and the propagation mode in the end portion 162 of the multicore optical fiber 150 are the same, i.e., both being cladding mode. As the cladding diameter of the multicore optical fiber 150 gradually increases in the transition portion 156, the propagation mode gradually transitions from the cladding mode (FIG. 15D) to core mode (FIGS. 15E and 15F) with the power split among the cores.

### Transmission Loss Simulation

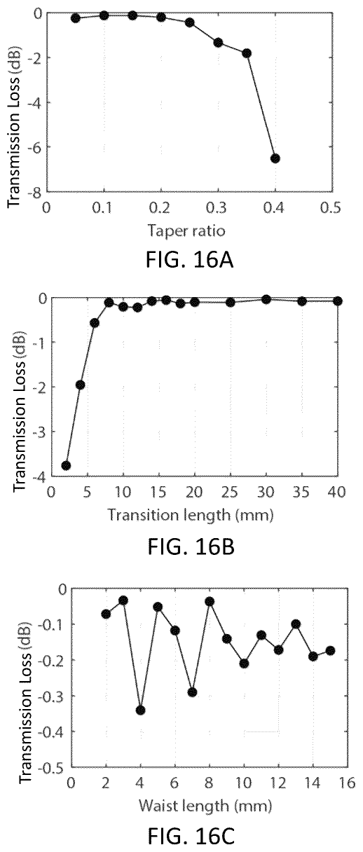

FIGS. 16A-16C show the simulated transmission loss (transition loss=−insertion loss, and insertion loss=|transmission loss|) for exemplary power splitter designs having various taper ratios, transition lengths, and waist lengths. For these simulations, the Thorlabs 980HP fiber (core diameter=3.5 μm, NA=0.2) is considered as the input single-core optical fiber, and the iXblue 4-core fiber (IXF-MC-4-SM-1060, core diameter=3.3 μm, NA=0.21) is considered as the output multicore optical fiber. The taper ratios for both the input single-core optical fiber and the output multicore optical fiber are the same, and the transition lengths of the input single-core optical fiber and the output multicore optical fiber are the same. As shown in FIGS. 16A and 16B, for the specific combination of the single-core and multicore optical fibers, a wide range of taper ratios (e.g., ≤0.25) and/or transition lengths (≥6 mm) and/or combinations thereof can be implemented to consistently achieve a low insertion loss of less than 0.5 dB. As further shown in FIG. 16C, the power splitter described herein allows for a wide range of waist lengths to be employed while consistently achieving low loss; however, a greater waist length may allow for larger fabrication tolerance.

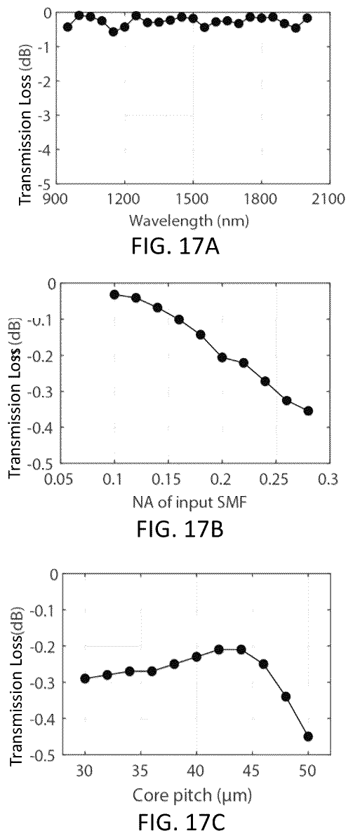

FIGS. 17A-17C are further simulation results showing the versatility of the power splitter described herein. For these simulations, the following parameters are employed: the splice taper is symmetrical about the splice location, and thus, taper ratio R_{S}=taper ratio R_{M}=0.2, transition length L_{TS}=transition length L_{TM}=8 mm, and waist length L_{w}=2 mm; the input single-core optical fiber is a single mode fiber; no bending applied.

As shown in FIG. 17A, low-loss operation can be consistently achieved for wavelengths ranging from 400 nm to 2000 nm. As further shown in FIG. 17B, low-loss operation can be achieved for a wide numerical aperture range for the input single-core optical fiber. FIG. 17C further demonstrates that low-loss operation can be achieved for a wide core pitch range for the output multicore optical fiber.

Table 1 below provides further simulation results for multicore optical fibers with different core arrangements, further demonstrating the versatility of the power splitter described herein. For the simulations in Table 1, the following parameters are employed: the splice taper is symmetrical about the splice location, and thus, taper ratio R_{S}=taper ratio R_{M}=0.2, transition length L_{TS}=transition length L_{TM}; the input single-core optical fiber is a single mode fiber; no bending applied. As shown, the power splitter described herein can be used for multicore optical fibers that have various number of cores and/or different core pitch values while consistently achieving low-loss operation.

TABLE 1

| Core numbers | 2 | 3 | 4 | 6 | 8 | 7 |
|---|---|---|---|---|---|---|
| Core layout | FIG. 4A | FIG. 4B | FIG. 4C | FIG. 4D | FIG. 4E | FIG. 4F |
| Core pitch (μm) | 50 | 50 | 50 | 50 | 50 | 50 |
| Core diameter (μm) | 9 | 9 | 9 | 12.5 | 12.5 | 12.5 |
| Cladding diameter (μm) | 125 | 125 | 125 | 220 | 220 | 220 |
| Core NA | 0.12 | 0.12 | 0.12 | 0.076 | 0.076 | 0.076 |
| Wavelength (nm) | 1550 | 1550 | 1550 | 1550 | 1550 | 1550 |
| Waist length (μm) | 2000 | 2000 | 2000 | 4000 | 4000 | 3480 |
| Transition length | 8000 | 8000 | 8000 | 13000 | 13000 | 13000 |
| L_{TS} = L_{TM} (μm) | | | | | | |
| Taper Ratio R_{S} = R_{M} | 0.2 | 0.2 | 0.2 | 0.2 | 0.2 | 0.2 |
| Loss (dB) | 0.06 | 0.03 | 0.07 | 0.12 | 0.13 | 0.02 |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A power splitter, comprising:
a single-core optical fiber, the single-core optical fiber comprising:
a fiber axis CL_{S};
a non-tapered portion having a cladding diameter D_{S}; and
a transition portion extending from the non-tapered portion from a first location to a second location, the transition portion have a transition length L_{TS} extending between the first location and the second location along the fiber axis CL_{S};
a multicore optical fiber, the multicore optical fiber comprising:
a fiber axis CL_{M};
a plurality of cores;
a non-tapered portion having a cladding diameter D_{M}; and
a transition portion extending from the non-tapered portion from a first location to a second location, the transition portion have a transition length L_{TM} extending between the first location and the second location along the fiber axis CL_{M};
wherein:
a terminal end of the single-core optical fiber is spliced to a terminal end of the multicore optical fiber at a splice location;
the terminal end of the single-core optical fiber and the terminal end of the multicore optical fiber comprise a common, splice diameter Dₛₚ;
at least one of a taper ratio R_{S} of the splice diameter Dₛₚ to the cladding diameter D_{S} of the non-tapered portion of the single-core optical fiber or a taper ratio R_{M} of the splice diameter Dₛₚ to the cladding diameter D_{M} of the non-tapered portion of the multicore optical fiber is greater than or equal to 0.05 and less than or equal to 0.4; and
at least one of the transition length L_{TS} of the single-core optical fiber or the transition length L_{TM} of the multicore optical fiber is greater than or equal to 2 mm;
wherein when the power splitter is in operation, the power splitter exhibits at least one of the following:
an insertion loss of the power splitter is less than or equal to 1 dB; or
a power distribution variance among the plurality of cores of the multicore optical fiber is less than or equal to 10%.

2. The power splitter of claim 1, wherein the single-core optical fiber comprises a single mode optical fiber.

3. The power splitter of claim 1, wherein the multicore optical fiber comprises uncoupled cores.

4. The power splitter of claim 1, further comprising a base, wherein:
the single-core optical fiber is coupled to the base at a first location at the base;
the multicore optical fiber is coupled to the base at a second location at the base;
the splice location is between the first location and the second location;
at least one of the spliced single-core optical fiber or the multicore optical fiber is bent between the first location at the base and the second location at the base such that when the power splitter is in operation, the power distribution variance among the plurality of cores of the multicore optical fiber is less than or equal to 10%.

5. The power splitter of claim 1, at least one of a bending radius of the single-core optical fiber or a bending radius of the multicore optical fiber is greater than or equal to 10 mm.

6. The power splitter of claim 1, wherein the transition length L_{TS} of the single-core optical fiber and/or the transition length L_{TM} of the multicore optical fiber satisfy at least one of:
wherein the transition length L_{TS} of the single-core optical fiber is greater than or equal to 2 mm; or
wherein the transition length L_{TS} of the single-core optical fiber is less than or equal to 100 mm; or
the transition length L_{TM} of the multicore optical fiber is greater than or equal to 2 mm; or
the transition length L_{TM} of the multicore optical fiber is less than or equal to 100 mm.

7. The power splitter of claim 1, wherein the taper ratio R_{S} of the splice diameter Dₛₚ to the cladding diameter D_{S} of the non-tapered portion of the single-core optical fiber and/or the taper ratio R_{M} of the splice diameter Dₛₚ to the cladding diameter D_{M} of the non-tapered portion of the multicore optical fiber satisfy at least one of:
wherein the taper ratio R_{S} of the splice diameter Dₛₚ to the cladding diameter D_{S} of the non-tapered portion of the single-core optical fiber is greater than or equal to 0.05 and less than or equal to 0.4; or
wherein the taper ratio R_{M} of the splice diameter Dₛₚ to the cladding diameter D_{M} of the non-tapered portion of the multicore optical fiber is greater than or equal to 0.05 and less than or equal to 0.4; or
wherein the taper ratio R_{S} of the splice diameter Dₛₚ to the cladding diameter D_{S} of the non-tapered portion of the single-core optical fiber is the same as the taper ratio R_{M} of the splice diameter Dₛₚ to the cladding diameter D_{M} of the non-tapered portion of the multicore optical fiber.

8. The power splitter of claim 1, wherein:
the single-core optical fiber further comprises an end portion extending from the transition portion of the single-core optical fiber to the terminal end of the single-core optical fiber;
the multicore optical fiber further comprises an end portion extending from the transition portion of the multicore optical fiber to the terminal end of the multicore optical fiber;
wherein the single-core optical fiber and/or the multicore optical fiber further satisfy at least one of:
wherein a length of the end portion of the single-core optical fiber and a length of the end portion of the multicore optical fiber are the same; or
wherein the cladding diameter D_{S} of the non-tapered portion of the single-core optical fiber and the cladding diameter D_{M} of the non-tapered portion of the multicore optical fiber are the same; or
wherein the transition length L_{TS} of the single-core optical fiber is the same as the transition length L_{TM} of the multicore optical fiber.

9. The power splitter of claim 1, wherein the insertion loss of the power splitter is less than or equal to 0.6 dB, less than or equal to 0.3 dB, or less than or equal to 0.2 dB.

10. A repeater, comprising at least power splitter of claim 1.

11. The repeater of claim 10, wherein the at least one power splitter comprises a plurality of power splitters, the repeater further comprising:
a plurality of pump lasers;
a coupler network configured for routing power from the plurality of pump lasers to the plurality of power splitters; and
a plurality of power amplifiers, wherein each of the plurality of power amplifiers is coupled to one of the plurality of power splitters.

12. The repeater of claim 11, wherein at least one power amplifier of the plurality of power amplifiers comprises a multicore fiber amplifier.

13. The repeater of claim 12, wherein the at least one power amplifier comprises a doped multicore optical fiber, and wherein the doped multicore optical fiber and the multicore optical fiber of at least one power splitter of the plurality of power splitters include the same number of cores.

14. A fiber segment, comprising:
a single-core optical fiber, the single-core optical fiber comprising:
a fiber axis CL_{S};
a non-tapered portion having a cladding diameter D_{S}; and
a transition portion extending from the non-tapered portion from a first location to a second location, the transition portion have a transition length L_{TS} extending between the first location and the second location along the fiber axis CL_{S};
a multicore optical fiber, the multicore optical fiber comprising:
a fiber axis CL_{M};
a plurality of cores;
a non-tapered portion having a cladding diameter D_{M}; and
a transition portion extending from the non-tapered portion from a first location to a second location, the transition portion have a transition length L_{TM} extending between the first location and the second location along the fiber axis CL_{M};
wherein:
a terminal end of the single-core optical fiber is spliced to a terminal end of the multicore optical fiber at a splice location;
the terminal end of the single-core optical fiber and the terminal end of the multicore optical fiber comprise a common, splice diameter Dₛₚ;
at least one of a taper ratio R_{S} of the splice diameter Dₛₚ to the cladding diameter D_{S} of the non-tapered portion of the single-core optical fiber or a taper ratio R_{M} of the splice diameter Dₛₚ to the cladding diameter D_{M} of the non-tapered portion of the multicore optical fiber is greater than or equal to 0.05 and less than or equal to 0.4; and
at least one of the transition length L_{TS} of the single-core optical fiber or the transition length L_{TM} of the multicore optical fiber is greater than or equal to 2 mm.

15. The fiber segment of claim 14, wherein:
the single-core optical fiber further comprises an end portion extending from the transition portion of the single-core optical fiber to the terminal end of the single-core optical fiber;
the multicore optical fiber further comprises an end portion extending from the transition portion of the multicore optical fiber to the terminal end of the multicore optical fiber;
wherein the single-core optical fiber and/or the multicore optical fiber further satisfy at least one of:
wherein a length the end portion of the single-core optical fiber and a length of the end portion of the multicore optical fiber are the same; or
wherein the cladding diameter D_{S} of the non-tapered portion of the single-core optical fiber and the cladding diameter D_{M} of the non-tapered portion of the multicore optical fiber are the same; or
wherein the transition length L_{TS} of the single-core optical fiber is the same as the transition length L_{TM} of the multicore optical fiber.

16. The fiber segment of claim 14, wherein the multicore optical fiber satisfies at least one of:
wherein the plurality of cores of the multicore optical fiber comprises greater than or equal to two cores; or
wherein the plurality of cores of the multicore optical fiber comprises less than or equal to forty cores.

17. The fiber segment of claim 14, wherein the multicore optical fiber comprises uncoupled cores.

18. A method of manufacturing a power splitter, the method comprising:
providing a fiber segment of claim 14;
coupling the single-core optical fiber to a base at a first location at the base; and
coupling the multicore optical fiber to the base at a second location at the base;
wherein the coupling of the single-core optical fiber to the base and the coupling of the multicore optical fiber to the base are performed such that the power distribution variance among the plurality of cores of the multicore optical fiber is less than or equal to 10%.

19. The method of claim 18, wherein the coupling of the single-core optical fiber to the base and the coupling of the multicore optical fiber to the base are performed such that at least one of the single-core optical fiber or the multicore optical fiber is bent between the first location at the base and the second location at the base.

20. The method of claim 18, wherein providing the fiber segment comprising:
splicing a single-core optical fiber to a multicore optical fiber; and
tapering the spliced single-core optical fiber and the multicore optical fiber to obtain the fiber segment.
